(19) United States
(12) Patent Application Publication
(10) Pub. No.: US 2026/0226846 A1
(43) Pub. Date: Aug. 6, 2026

(54) VARIABLE GEOMETRY TURBINE

(71) Applicant: Cummins Ltd, London (GB)

(72) Inventors: Kyle Hinchliffe, Huddersfield (GB); Christopher Normington, Huddersfield (GB); Matthew William Edwards, Huddersfield (GB); Robert Holroyd, Huddersfield (GB)

(21) Appl. No.: 19/151,087

(22) PCT Filed: Jan. 26, 2024
(86) PCT No.: PCT/GB2024/050215

§ 371 Date: Jul. 25, 2025

(30) Foreign Application Priority Data
Jan. 27, 2023 (GB) 2301238.8

(51) Int. Cl. F01D 17/16; F02B 37/22

(52) U.S. Cl. CPC F01D 17/16; F02B 37/225

(57) ABSTRACT

A nozzle ring for a variable geometry turbine comprises: a generally annular wall; an inner flange; an outer flange; and two protrusions. The inner flange is generally perpendicular to the generally annular wall and extends from a radially inner edge of the generally annular wall. The outer flange is generally perpendicular to the generally annular wall and extends from a radially outer edge of the generally annular wall. The two protrusions extend from one of the inner or outer flange towards the other one of the inner or outer flange. At least one of the two protrusions extends only partially towards the other one of the inner or outer flange. The two protrusions define a first gap therebetween. The generally annular wall and the two protrusions define a second gap between the generally annular wall and both of the two protrusions. In some embodiments, the two protrusions are such that the first gap is tapered so that a dimension of the gap is smaller at a distal end of the protrusions and larger proximate to the inner or outer flange from which the two protrusions extend. In some embodiments, a radial extent of the second gap is less than a radial extent of the two protrusions. In use, the second gap receives an arcuate head portion of a support and the first gap receives an intermediate portion of the support. The nozzle ring may be suitable for use in a variable geometry turbocharger.

### CROSS-REFERENCE TO RELATED APPLICATION

This application is a US national stage of and claims the priority benefit of International Patent Application No. PCT/GB2024/050215, Jan. 26, 2024, which claims priority to UK Patent Application No. 2301238.8, filed Jan. 27, 2023, the entire contents and disclosures of which are incorporated herein by reference.

### TECHNICAL FIELD

The present invention relates to a variable geometry turbine and component parts thereof. The variable geometry turbine may, for example, be for use in a turbocharger for an internal combustion engine. In particular, the present invention relates to a new nozzle ring for a variable geometry turbine, a new support for a nozzle ring, and a new mechanism for engagement between a nozzle ring and one or more supports.

### BACKGROUND

Turbochargers are known devices for supplying air to the intake of an internal combustion engine at pressures above atmospheric pressure (boost pressures). A conventional turbocharger comprises an exhaust gas driven turbine wheel mounted on a rotatable shaft within a turbine housing. Rotation of the turbine wheel rotates a compressor wheel that is mounted on the other end of the shaft and within a compressor housing. The compressor wheel delivers compressed air to the engine intake manifold. The turbocharger shaft is conventionally supported by journal and thrust bearings, including appropriate lubricating systems, located within a central bearing housing connected between the turbine and compressor wheel housings.

In known turbochargers, the turbine comprises a turbine chamber within which the turbine wheel is mounted, an inlet passageway defined between facing, generally annular walls arranged around the turbine chamber, an inlet volute arranged around the inlet passageway, and an outlet passageway extending from the turbine chamber. The passageways and chambers communicate in such a way that pressurised exhaust gas admitted to the inlet volute flows through the inlet passageway to the outlet passageway via the turbine and rotates the turbine wheel. It is also known to trim turbine performance by providing vanes, referred to as nozzle vanes, in the inlet passageway so as to deflect gas flowing through the inlet passageway towards the direction of rotation of the turbine wheel.

Turbines may be of a fixed or variable geometry type. Variable geometry turbines differ from fixed geometry turbines in that the size of the inlet passageway can be varied to optimise gas flow velocities over a range of mass flow rates so that the power output of the turbine can be varied to suit varying engine demands. For instance, when the volume of exhaust gas being delivered to the turbine is relatively low, the velocity of the gas reaching the turbine wheel is maintained at a level that ensures efficient turbine operation by reducing the size of the inlet passageway.

In one known type of variable geometry turbine, an axially moveable wall member, generally referred to as a “nozzle ring”, defines one wall of the inlet passageway. The position of the nozzle ring relative to a facing wall of the inlet passageway is adjustable to control an axial width of the inlet passageway. Thus, for example, as gas flowing through the turbine decreases, the inlet passageway width may also be decreased to maintain gas velocity and to optimise turbine output. Such nozzle rings comprise a generally annular wall and inner and outer axially extending flanges. The flanges extend into a cavity defined in the turbine housing, which is a part of the housing that in practice is provided by the bearing housing, which accommodates axial movement of the nozzle ring. The nozzle ring is supported by two support rods, which extend partially through the bearing housing. In this way, the displaceable nozzle ring is exposed to the hot exhaust gases used to drive the turbine. The bearing housing, however, is typically water-cooled and so the nozzle ring will generally reach a higher temperature than the housing and its temperature will also vary much more rapidly than that of the housing. As a result, the ring may expand and contract radially relative to the housing. Since the housing is provided with cooling, the spacing between the support rods may vary much less than the diameter of the nozzle ring in response to operating temperature changes. If the support rods were securely fixed to the ring, this differential expansion could only be accommodated by mechanical distortion of the interconnected components, which is not acceptable.

In efforts to address this problem, variable geometry turbines have been developed in which the support rods have been connected to the nozzle ring using a linkage mechanism which allows for limited relative movement in the radial direction. The allowed movement may be sufficient to accommodate the maximum expected differential expansion, but limited so that the mechanism is still able to position the ring accurately in the housing.

In addition to the operating requirements mentioned above, the interconnections between the ring and the rods may prevent excessive tilting of the ring relative to a plane perpendicular to the rods as this would affect the operating clearances of the linkage mechanism and thereby reduce performance. The ring may also be accurately positioned in the axial direction to ensure that the mechanism responds in a predictable manner to a control input. All this has to be achieved in a linkage mechanism that is robust enough to last for several thousands of hours running in the corrosive exhaust gas of an engine, at high temperatures, with no lubrication and in conditions in which mechanical vibration of the interconnected components is inevitable. Such performance has proved difficult to achieve.

The nozzle ring may be provided with vanes that extend into the inlet passageway and through slots provided on the facing wall of the inlet passageway to accommodate movement of the nozzle ring. Alternatively, vanes may extend from the fixed wall through slots provided in the nozzle ring. Generally the nozzle ring is supported on rods extending parallel to the axis of rotation of the turbine wheel and is moved by an actuator that axially displaces the rods. Various forms of actuators are known for use in variable geometry turbines, including pneumatic, hydraulic and electric actuators that are mounted externally of the turbocharger and connected to the variable geometry system via appropriate linkages.

It may be desirable to provide a variable geometry turbine at least partially addresses one or more problems associated with known variable geometry turbines, whether identified herein or otherwise.

According to the first aspect of the present disclosure there is provided a nozzle ring for a variable geometry turbine, the nozzle ring comprising: a generally annular wall; an inner flange that is generally perpendicular to the generally annular wall, and which extends from a radially inner edge of the generally annular wall; an outer flange that is generally perpendicular to the generally annular wall, and which extends from a radially outer edge of the generally annular wall; and two protrusions extending from one of the inner or outer flange towards the other one of the inner or outer flange, at least one of the two protrusions extending only partially towards the other one of the inner or outer flange; wherein the two protrusions define a first gap therebetween; wherein the generally annular wall and the two protrusions define a second gap between the generally annular wall and both of the two protrusions; and wherein a radial extent of the second gap is less than a radial extent of the two protrusions.

According to the second aspect of the present disclosure there is provided a nozzle ring for a variable geometry turbine, the nozzle ring comprising: a generally annular wall; an inner flange that is generally perpendicular to the generally annular wall, and which extends from a radially inner edge of the generally annular wall; an outer flange that is generally perpendicular to the generally annular wall, and which extends from a radially outer edge of the generally annular wall; and two protrusions extending from one of the inner or outer flange towards the other one of the inner or outer flange, at least one of the two protrusions extending only partially towards the other one of the inner or outer flange; wherein the two protrusions define a first gap therebetween; wherein the generally annular wall and the two protrusions define a second gap between the generally annular wall and both of the two protrusions; and wherein the two protrusions are such that the first gap is tapered so that a dimension of the gap is smaller at a distal end of the protrusions and larger proximate to the inner or outer flange from which the two protrusions extend.

It will be appreciated that an axis of the nozzle ring may be defined as an axis which is perpendicular to the generally annular wall member and which passes through a centre of the generally annular wall member. Furthermore, when referring to features of the nozzle ring, the terms axial, radial and circumferential may be defined relative to this axis.

The nozzle rings according to the first and second aspects of the disclosure are advantageous, as now discussed. In use, the nozzle rings may be movably mounted within a variable geometry turbine. In particular, the nozzle ring may be movably mounted such that it can move axially relative to other components of the variable geometry turbine. The nozzle ring may therefore be referred to as an axially moveable wall member. The nozzle ring may define one wall of an inlet passageway for the variable geometry turbine.

The two protrusions may extend from a curved surface of one of the inner or outer flange towards the other one of the inner or outer flange. The curved surface may be referred to as a side wall of the inner or outer flange. The two protrusions may extend from an interior surface of the nozzle ring.

As will be discussed further below, the nozzle ring may be supported by two rods extending parallel to the axis of the nozzle ring and may be moved by an actuator that axially displaces the rods. In particular, the two rods may be disposed on the same side of the annular wall member as the inner and outer flanges. Various forms of actuators are known for use in variable geometry turbines, including pneumatic, hydraulic and electric actuators that are mounted externally of the turbocharger and connected to the variable geometry system via appropriate linkages.

In some existing variable geometry turbochargers, the two rods that support a nozzle ring are connected to the nozzle ring using rivets. One example arrangement is disclosed in U.S. Pat. No. 6,401,563.

In an earlier patent application (GB2111046.5, which was unpublished at the priority date of the present application), the present applicant proposed a nozzle ring generally of the type of the first and second aspects of the present disclosure. This may be referred to as a rivetless nozzle ring. The two protrusions provide a feature for engagement with a supporting rod. The supporting rod may comprise an elongate generally cylindrical portion that may be supported in a bush or the like on a housing for linear movement relative to said housing. The supporting rod may further comprise an arcuate head portion disposed adjacent one end of the generally cylindrical portion, the head portion extending generally perpendicular to an axis of the generally cylindrical portion. Such an arrangement may engage with the two protrusions of the nozzle ring according to the first and second aspects of the disclosure, as now discussed. In use, the arcuate head portion may be received in the second gap between the generally annular wall and the two protrusions. An axial dimension of the arcuate head portion may generally match an axial dimension of the second gap between the generally annular wall and the two protrusions (i.e. an axial clearance between the arcuate head portion and the nozzle ring may be minimised). As such, axial movement of the supporting rod in either direction will cause the nozzle ring to move axially. A portion of the supporting rod between the arcuate head portion and the generally cylindrical portion may be received in the first gap between the two protrusions.

The nozzle ring according to the first and second aspects of the disclosure is advantageous over existing arrangements that use rivets since it avoids various problems associated with riveted arrangements. In particular, since there are no rivets on the generally annular wall, there is, in general, greater design freedom for the placement of vanes and/or balance apertures on the generally annular wall. Furthermore, the connection of the supporting rods to the nozzle ring is less involved and uses fewer parts. Furthermore, the nozzle ring according to the first and second aspects of the disclosure can be more easily disengaged from the supporting rods, which may facilitate easier replacement of only one of these parts (rather than the whole permanent or semi-permanent assembly) as desired. Furthermore, the nozzle rings according to the first and second aspects of the disclosure are advantageous over existing arrangements that do not use rivets.

In the arrangement disclosed in GB2111046.5, an intermediate portion of the support rods between the arcuate head portion and the generally cylindrical portion defines two parallel surfaces. In use, the intermediate portion is received in the first gap of the nozzle ring (between the two protrusions). A clearance between the two protrusions and the portion of the supporting rod between the arcuate head portion and the generally cylindrical portion is minimised such that any torque applied to the nozzle ring (for example by exhaust gases) can be carried by the surfaces of the two protrusions that define the first gap.

In GB2555872 the present applicant proposed that in the turbine of a turbomachine of the kind in which, at a gas inlet between a nozzle ring and a shroud, vanes project from the nozzle through slots in the shroud, one “conformal” portion of a lateral (i.e. transverse to the rotational axis) surface of each vane substantially conforms to the shape of a corresponding “conformal” portion of a lateral surface of the corresponding slot, so as to enable the respective conformal portions of the surfaces to be placed relative to each other with only a small clearance between them. An advantage of this is that gas flow between the respective conformal portions of the surfaces of the vane and the slot can be substantially reduced. This reduces leakage of gas into or out of a recess on the other side of the shroud from the nozzle ring. Such leakage reduces the circumferential redirection of the gas caused by the vanes, and has been found to cause significant losses in efficiency. In such an arrangement, the conformal portions of the vane surface and slot surface can be positioned close to each other, or even in contact, at low temperature (such as room temperature). With such an arrangement, the torque applied to the nozzle ring (for example by exhaust gases) can be carried by the shroud. In order to allow this whilst mitigating the risk of the nozzle ring and the shroud engaging such that the nozzle ring becomes stuck, at increased range of movement of the nozzle ring relative to the support rods (also referred to as nozzle lash) is provided. In effect, a greater range of rotational movement of the nozzle ring (about its axis) relative to the support rods (between two end positions) is provided such that, in use, the nozzle ring will never reach either of the two end positions and therefore will never be rotationally constrained by the push rods.

Advantageously, the nozzle rings according to the first and second aspects of the disclosure provide arrangements similar to those disclosed in GB2111046.5 but which can be more easily combined with the conformal vanes and slots (and the associated advantage of improved turbine stage efficiency) taught in GB2555872, as now discussed.

In order to achieve a rivetless nozzle ring that can benefit from the advantages of conformal vanes and slots, sufficient clearance should be provided between the nozzle ring and the support rods such that the nozzle ring is never, in use, rotationally constrained by the support rods. The inventors have realized that, in use, each of the support rods will rotate about the axis of the cylindrical portion (that is received in a guide bush) freely until it contacts the nozzle ring. Furthermore, if the first gap and the intermediate portion of the support rod received therein are each defined by two parallel surfaces, such rotation will reduce a clearance between the support rods and the nozzle ring. In effect, the two parallel surfaces of the intermediate portion mean that the clearance between the nozzle ring and the support rods is dependent on the rotation of the support rods. As a result, in order to ensure that the nozzle ring will never be rotationally constrained by the push rods a further increased clearance would be required between the nozzle ring and the support rods.

In practice, the axis of the support rods will be at a radial position that is intermediate the inner flange and the outer flange, for example close to halfway between the inner flange and the outer flange.

It may be generally desirable to maximise a radial extent of the two protrusions between the inner flange and the outer flange. However, it will be appreciated that this maximization may be subject to the following constraints. First, in order to engage a support with the two protrusions of the nozzle ring, an arcuate head portion of the supporting rod may be aligned radially with the radial gap defined between distal ends of the two protrusions and the other one of the inner or outer flange and then moved axially towards the generally annular wall through this radial gap. It will be appreciated that this may impose a maximum radial extent of one of the two protrusions between the inner flange and the outer flange. Second, in some embodiments, the second gap (defined between the generally annular wall and the two protrusions) may be at least partially formed and/or finished using a cutting tool having a cutting portion that moves axially through the radial gap defined between distal ends of the two protrusions and the other one of the inner or outer flange and then radially towards the two protrusions to form or finish the second gap. Again, allowing for sufficient space for the cutting portion and any support therefor may impose a maximum radial extent of the two protrusions between the inner flange and the outer flange. In some embodiments, the protrusions may be finished and/or formed using electrochemical machining. For such embodiments, the two protrusions may be finished without the use of a cutting tool and therefore the constraint imposed by a cutting tool may not apply. For example, in some embodiments, the radial extent of the at least one of the two protrusions extending only partially towards the other one of the inner or outer flange may be between 0.35 and 0.45 times the radial distance between the inner flange and the outer flange.

With the nozzle ring according to the first aspect of the disclosure, a radial extent of the second gap is less than a radial extent of the two protrusions. Advantageously, such an arrangement may allow for a reduced radial gap between distal ends of the two protrusions and the other one of the inner or outer flange. In other words, such an arrangement can allow the two protrusions to extend further towards the other one of the inner or outer flange, as now discussed.

Suppose that there is a radial gap A between the inner and outer flanges. As explained above, in some embodiments, the second gap (defined between the generally annular wall and the two protrusions) may be at least partially formed and/or finished using a cutting tool having a cutting portion that moves axially through the radial gap defined between distal ends of the two protrusions and the other one of the inner or outer flange and then radially towards the two protrusions to form or finish the second gap. Allowing for sufficient space for the cutting portion and any support therefor may impose a maximum radial extent of the two protrusions between the inner flange and the outer flange. For example, if a radial extent of the support for the cutting portion is B and the radial extent of the second gap is equal to the radial extent of the two protrusions then the radial extent of the two protrusions will be less than (A−B)/2. That is, the radial extent of the two protrusions will be less than A/2. However, if the radial extent of the second gap C is less than a radial extent of the two protrusions D by some amount E (i.e. C=D−E) then the radial extent of the second gap will be less than (A−B−E)/2. But the radial extent of the two protrusions D is C+E so the radial extent of the two protrusions will be less than (A−B+E)/2. That is, the maximum radial extent of the two protrusions D is now increased by E/2.

Advantageously, this may allow the protrusions to extend further from one of the inner and outer flanges such that protrusions radially overlap with the centre line of the cylindrical portion of the support rods. Such an arrangement may, for example, be used with wherein the portion of the push rod received in the first gap is generally cylindrical. Such an arrangement would eliminate any dependence of the clearance between the nozzle ring and the support rods on the rotation of the support rods about their axes.

With the nozzle ring according to the second aspect of the disclosure, the first gap is tapered (so that a dimension of the gap is smaller at a distal end of the protrusions and larger proximate to the inner or outer flange from which the two protrusions extend). With such an arrangement, the first gap may be sufficiently tapered such that the distal end of the protrusions can provide a physical stop that limits relative rotational movement of the nozzle ring relative to the support rods. That is, it is the distal end of the protrusions that defines the clearance between the nozzle ring and the support rods. Furthermore, the distal end of the protrusions will, in use, be close to a centre line of the cylindrical portion of the support rods. Advantageously, this limits the amount of additional clearance that should be provided to accommodate rotation of the support rods about their axes. The first gap being tapered avoids the need for an excessively large clearance to be provided between the nozzle ring and the support rods, which may lead to performance variability. The closer the distal end of the protrusions are to the centre line of the cylindrical portion of the support rods, the smaller will be the dependence of the clearance between the nozzle ring and the support rods on the rotation of the support rods about their axes.

In some embodiments of the nozzle ring according to the second aspect of the present disclosure, a radial extent of the second gap may be less than a radial extent of the two protrusions.

In some embodiments of the nozzle ring according to the second aspect of the present disclosure, the surfaces of each of the two protrusions that define the first gap may be inclined relative to each other by any angle. In some embodiments, the surfaces of each of the two protrusions that define the first gap are inclined relative to each other by an angle that is sufficient to accommodate the typical range of rotation of the supports of the nozzle ring in normal use.

In some embodiments of the nozzle ring according to the second aspect of the present disclosure, the surfaces of the two protrusions that define the first gap may be inclined relative to each other by at least 8 degrees so as to provide the tapered first gap.

The surfaces of each of the two protrusions that define the first gap may be inclined at an angle of at least 4 degrees, for example at least 5 degrees such that the surfaces of the two protrusions are inclined relative to each other by at least 8 degrees, for example at least 10 degrees.

The inner and outer flanges may extend further from the generally annular wall than the two protrusions.

The two protrusions may be integrally formed with the one of the inner and outer flanges from which they extend.

In some embodiments, both of the two protrusions extend only partially towards the other one of the inner or outer flange.

A radial extent of the at least one of the two protrusions extending only partially towards the other one of the inner or outer flange is between 0.25 and 0.75 times a radial distance between the inner flange and the outer flange.

For embodiments of the first aspect of the present disclosure, a radial extent of the at least one of the two protrusions extending only partially towards the other one of the inner or outer flange may be between 0.25 and 0.5 times a radial distance between the inner flange and the outer flange. For example, in some such embodiments, the radial extent of the at least one of the two protrusions extending only partially towards the other one of the inner or outer flange may be between 0.3 and 0.5 times the radial distance between the inner flange and the outer flange. In some such embodiments, the radial extent of the at least one of the two protrusions extending only partially towards the other one of the inner or outer flange may be between 0.35 and 0.45 times the radial distance between the inner flange and the outer flange. In one such embodiment, the radial extent of the at least one of the two protrusions extending only partially towards the other one of the inner or outer flange may be around 0.42 times the radial distance between the inner flange and the outer flange.

For embodiments of the first aspect of the present disclosure (i.e. for which a radial extent of the second gap is less than a radial extent of the two protrusions), a radial extent of the at least one of the two protrusions extending only partially towards the other one of the inner or outer flange may be greater than 0.5 times a radial distance between the inner flange and the outer flange. For example, in some such embodiments, the radial extent of the at least one of the two protrusions extending only partially towards the other one of the inner or outer flange may be between 0.4 and 0.7 times the radial distance between the inner flange and the outer flange. In some such embodiments, the radial extent of the at least one of the two protrusions extending only partially towards the other one of the inner or outer flange may be between 0.5 and 0.6 times the radial distance between the inner flange and the outer flange. In one such embodiment, the radial extent of the at least one of the two protrusions extending only partially towards the other one of the inner or outer flange may be around 0.55 times the radial distance between the inner flange and the outer flange.

The generally annular wall may support a plurality of circumferentially spaced inlet vanes each of which extends axially away from a surface of the generally annular wall opposite from the inner and outer flanges.

A plurality of axially extending apertures may be provided through the generally annular wall.

At least some of the axially extending apertures provided through the generally annular wall may be located between the inlet vanes.

The nozzle ring may further comprise a second set of two protrusions extending from one of the inner or outer flange towards the other one of the inner or outer flange, at least one of the second set of two protrusions extending only partially towards the other one of the inner or outer flange; wherein the two protrusions of the second set define a third gap therebetween; and wherein the generally annular wall and the two protrusions of the second set define a fourth gap between the generally annular wall and both of the two protrusions of the second set.

The second set of two protrusions may be such that the third gap is tapered so that a dimension of the gap is smaller at a distal end of the protrusions of the second set and larger proximate to the inner or outer flange from which the two protrusions of the second set extend.

A radial extent of the fourth gap may be less than a radial extent of the second set of two protrusions.

According to the third aspect of the present disclosure there is provided a support for a nozzle ring, the support comprising: a body, the body comprising: an elongate portion; and an arcuate head portion disposed adjacent one end of the elongate portion, the head portion extending generally perpendicular to an axis of the elongate portion; wherein the arcuate head portion defines a two opposed curved surfaces and wherein at least one of the two opposed curved surfaces defines one or more protrusions therefrom; and wherein a portion of the body proximate the arcuate head portion is generally cylindrical.

The support according to the third aspect of the disclosure is advantageous, as now discussed. The support according to the third aspect of the disclosure is generally of the type disclosed in GB2111046.5 (which was unpublished at the priority date of the present application), the present applicant proposed a nozzle ring generally of the type of the first and second aspects of the present disclosure,

The support according to the third aspect of the disclosure may be suitable for supporting a nozzle ring according to the first or second aspects of the disclosure. In particular, as discussed above in relation to the nozzle rings according to the first aspect of the disclosure, the support according to the second aspect of the disclosure may engage with the two protrusions of the nozzle rings according to the first and second aspects of the disclosure.

In the arrangement disclosed in GB2111046.5, an intermediate portion of the support rods between the arcuate head portion and the generally cylindrical portion defines two parallel surfaces. In use, the intermediate portion is received in the first gap of the nozzle ring (between the two protrusions). A clearance between the two protrusions and the portion of the supporting rod between the arcuate head portion and the generally cylindrical portion is minimised such that any torque applied to the nozzle ring (for example by exhaust gases) can be carried by the surfaces of the two protrusions that define the first gap.

In contrast, the portion of the body of the support according to the third aspect of the disclosure proximate the arcuate head portion is generally cylindrical. This is advantageous, since the support for a nozzle ring according to the third aspect of the disclosure provides an arrangements similar to those disclosed in GB2111046.5 but which can be more easily combined with the conformal vanes and slots (and the associated advantage of improved turbine stage efficiency) taught in GB2555872, as now discussed.

As explained above, in order to achieve a rivetless nozzle ring that can benefit from the advantages of conformal vanes and slots, sufficient clearance should be provided between the nozzle ring and the support rods such that the nozzle ring is never, in use, rotationally constrained by the support rods. The inventors have realized that, in use, each of the support rods will rotate about the axis of the cylindrical portion (that is received in a guide bush) freely until it contacts the nozzle ring. Furthermore, if the first gap and the intermediate portion of the support rod received therein are each defined by two parallel surfaces, such rotation will reduce a clearance between the support rods and the nozzle ring. In effect, the two parallel surfaces of the intermediate portion mean that the clearance between the nozzle ring and the support rods is dependent on the rotation of the support rods. As a result, in order to ensure that the nozzle ring will never be rotationally constrained by the push rods a further increased clearance would be required between the nozzle ring and the support rods.

In practice, the axis of the support rods will be at a radial position that is intermediate the inner flange and the outer flange, for example close to halfway between the inner flange and the outer flange.

With the support for a nozzle ring according to the third aspect of the disclosure, the portion of the body that is proximate the arcuate head portion (which in use is received in the first gap) is cylindrical. Such an arrangement eliminates any dependence of the clearance between the nozzle ring and the support rods on the rotation of the support rods about their axes. Advantageously, this limits the amount of additional clearance that should be provided to accommodate rotation of the support rods about their axes.

The two opposed curved surfaces of the arcuate head portion may have a curvature that generally matches the inner and/or outer flange of a nozzle ring according to the first or second aspect of the disclosure. In use, one of the two opposed curved surfaces of the arcuate head portion may be disposed adjacent the one of the inner or outer flange from which the two protrusions extend. For example, in use, one of the two opposed curved surfaces of the arcuate head portion may be disposed adjacent the outer flange of the nozzle ring.

The one or more protrusions from at least one of the two opposed curved surfaces may extend from the one of the two opposed curved surfaces of the arcuate head portion that, in use, is disposed adjacent the one of the inner or outer flange from which the two protrusions extend.

A clearance is provided between the two protrusions of the nozzle ring and the cylindrical portion of the support that is proximate the arcuate head portion. This clearance allows for different thermal expansion of the nozzle ring and the supports. In use, the support and will tend to rotate about an axis of the elongate portion until it contacts the nozzle ring. In use, the protrusions from one of the opposed arcuate surfaces may contact an adjacent surface of the inner or outer flange of the nozzle ring of the first aspect or the second aspect. Such contact may provide a physical stop and limit the rotation of the supports about the axis of the elongate portion.

A bisector of the arcuate head portion in a plane perpendicular to the axis of the generally cylindrical portion may be offset from said axis.

A recess may be defined on the end of the elongate portion adjacent the arcuate head portion. The recess may be defined on a side of the elongate portion opposite to a direction in which the bisector of the arcuate head portion is offset from said axis in the plane perpendicular to said axis.

According to the fourth aspect of the present disclosure there is provided a kit of parts comprising: a nozzle ring for a variable geometry turbine, the nozzle ring comprising: a generally annular wall; an inner flange that is generally perpendicular to the generally annular wall, and which extends from a radially inner edge of the generally annular wall; an outer flange that is generally perpendicular to the generally annular wall, and which extends from a radially outer edge of the generally annular wall; and two protrusions extending from one of the inner or outer flange towards the other one of the inner or outer flange, at least one of the two protrusions extending only partially towards the other one of the inner or outer flange; wherein the two protrusions define a first gap therebetween; and wherein the generally annular wall and the two protrusions define a second gap between the generally annular wall and both of the two protrusions; and at least one support for a nozzle ring, the support comprising: a body, the body comprising: an elongate portion; and an arcuate head portion disposed adjacent one end of the elongate portion, the head portion extending generally perpendicular to an axis of the elongate portion; wherein an external axial dimension of the arcuate head portion of the at least one support generally matches an internal axial dimension of the second gap; wherein the nozzle ring and the at least one support are configured such that the arcuate head portion of the at least one support is receivable in the second gap and a portion of the at least one support is disposed in the first gap; and wherein the nozzle ring and the or each support are arranged such that when the arcuate head portion of the at least one support is received in the second gap and a portion of the at least one support is disposed in the first gap there is an angular clearance between the nozzle ring and the or each support, the angular clearance being localized and defined by two portions of the nozzle ring and wherein a line that connects said two portions of the nozzle ring passes through, or is proximate to an axis of the elongate portion.

The kit of parts according to the fourth aspect of the disclosure is advantageous, as now discussed. In an earlier patent application (GB2111046.5, which was unpublished at the priority date of the present application), the present applicant proposed a kit of parts generally of the type of the fourth aspect of the present disclosure. Advantageously, the kit of parts according to the fourth aspect of the disclosure provides an arrangement similar to that disclosed in GB2111046.5 but which can be more easily combined with the conformal vanes and slots (and the associated advantage of improved turbine stage efficiency) taught in GB2555872, as now discussed.

In order to achieve an assembly (of a rivetless nozzle ring and at least one support) that can benefit from the advantages of conformal vanes and slots, sufficient clearance should be provided between the nozzle ring and the supports such that the nozzle ring is never, in use, rotationally constrained by the supports. The inventors have realized that, in use, each of the supports will rotate about the axis of the cylindrical portion (that is received in a guide bush) freely until it contacts the nozzle ring. Furthermore, if the first gap and the intermediate portion of the support rod received therein are each defined by two (extended) parallel surfaces, such rotation will reduce a clearance between the support rods and the nozzle ring. In effect, the two parallel surfaces of the intermediate portion mean that the clearance between the nozzle ring and the supports is dependent on the rotation of the support rods. As a result, in order to ensure that the nozzle ring will never be rotationally constrained by the push rods a further increased clearance would be required between the nozzle ring and the support rods.

With the kit of parts according to the fourth aspect of the disclosure, the angular clearance between the nozzle ring and the or each support is localized is defined by two portions of the nozzle ring such that a line that connects said two portions of the nozzle ring passes through, or is proximate to an axis of the elongate portion. Advantageously, this limits the extent to which the orientation of the supports affects the clearance between the nozzle ring and the or each support. The closer the line that connects said two portions of the nozzle ring is to the axis of the elongate portion, the smaller will be the dependence of the clearance on the orientation of the supports. Furthermore, the more localized the clearance is, the smaller will be the dependence of the clearance on the orientation of the supports.

Advantageously, the kit of parts according to the fourth aspect limits the amount of additional clearance that should be provided to accommodate rotation of the support rods about their axes. This avoids the need for an excessively large clearance to be provided between the nozzle ring and the support rods, which may lead to performance variability.

In practice, the axis of the supports may be at a radial position that is intermediate the inner flange and the outer flange, for example close to halfway between the inner flange and the outer flange.

According to the fifth aspect of the present disclosure there is provided an assembly comprising: a nozzle ring for a variable geometry turbine, the nozzle ring comprising: a generally annular wall; an inner flange that is generally perpendicular to the generally annular wall, and which extends from a radially inner edge of the generally annular wall; an outer flange that is generally perpendicular to the generally annular wall, and which extends from a radially outer edge of the generally annular wall; and two protrusions extending from one of the inner or outer flange towards the other one of the inner or outer flange, at least one of the two protrusions extending only partially towards the other one of the inner or outer flange; wherein the two protrusions define a first gap therebetween; and wherein the generally annular wall and the two protrusions define a second gap between the generally annular wall and both of the two protrusions; and at least one support for a nozzle ring, the support comprising: a body, the body comprising: an elongate portion; and an arcuate head portion disposed adjacent one end of the elongate portion, the head portion extending generally perpendicular to an axis of the elongate portion; wherein an external axial dimension of the arcuate head portion of the at least one support generally matches an internal axial dimension of the second gap; wherein the arcuate head portion of the at least one support is received in the second gap and a portion of the at least one support is disposed in the first gap; and wherein the nozzle ring and the or each support are arranged such that there is an angular clearance between the nozzle ring and the or each support, the angular clearance being localized and defined by two portions of the nozzle ring and wherein a line that connects said two portions of the nozzle ring passes through, or is proximate to an axis of the elongate portion.

According to the sixth aspect of the present disclosure there is provided an assembly comprising the kit of parts according to the fourth aspect of the present disclosure wherein the arcuate head portion of the at least one support is received in the second gap and a portion of the at least one support is disposed in the first gap; and wherein the nozzle ring and the or each support are arranged such that there is an angular clearance between the nozzle ring and the or each support, the angular clearance being localized and defined by two portions of the nozzle ring and wherein a line that connects said two portions of the nozzle ring passes through, or is proximate to an axis of the elongate portion.

The assemblies according to the fifth and sixth aspects of the present disclosure are advantageous for the same reasons discussed above with reference to the kit of parts of the fourth aspect of the present disclosure.

In any of the fourth, fifth or sixth aspects of the present disclosure, the nozzle ring may comprise a nozzle ring according to the first aspect of the present disclosure or the second aspect of the present disclosure.

In any of the fourth, fifth or sixth aspects of the present disclosure, the or each at least one support may comprises a support according to the third aspect of the present disclosure.

According to the seventh aspect of the present disclosure there is provided a variable geometry turbine comprising: a housing; a turbine wheel supported in the housing for rotation about an axis; a nozzle ring according to the first aspect of the present disclosure or the second aspect of the present disclosure or a kit of parts according to the fourth aspect of the present disclosure or an assembly according to the fifth aspect of the present disclosure or the sixth aspect of the present disclosure; a cavity provided in the housing for receipt of the inner and outer flanges of the nozzle ring, the nozzle ring being axially movable relative to the housing to vary the extent to which the inner and outer flanges of the nozzle are received in the cavity; and an inlet passageway extending radially inwards towards the turbine wheel and defined between a face of the generally annular wall of the nozzle ring and an opposing wall of the housing, such that said axial movement of the nozzle ring relative to the housing varies the axial width of the inlet passageway.

For embodiments wherein the generally annular wall of the nozzle ring supports a plurality of circumferentially spaced inlet vanes, the opposing wall of the housing may defines a plurality of circumferentially spaced slots arranged such that each of the plurality of inlet vanes is received in a respective one of the plurality of slots.

The opposing wall may be referred to as a shroud. Each slot may be an elongate through aperture in the wall. In use, each slot may receive at least a portion of an inlet vane of the nozzle ring. A shape of the slot of each rotatable member may generally match the generally uniform shape of such an inlet vane of a nozzle ring in cross section in a plane perpendicular to an axis of the nozzle ring.

The inlet vanes and the slots may be arranged as disclosed in GB2555872, which is incorporated herein in its entirety by reference. That is, one “conformal” portion of a lateral (i.e. transverse to the rotational axis) surface of each vane may substantially conforms to the shape of a corresponding “conformal” portion of a lateral surface of the corresponding slot, so as to enable the respective conformal portions of the surfaces to be placed relative to each other with only a small clearance between them.

According to the eighth aspect of the present disclosure there is provided a turbocharger comprising the variable geometry turbine according to the seventh aspect of the present disclosure.

According to the ninth aspect of the present disclosure there is provided a method of assembling a variable geometry turbine, the method comprising: providing a nozzle ring comprising a plurality of inlet vanes; providing two supports for a nozzle ring; engaging the two supports with the nozzle ring so as to form a nozzle ring assembly; coupling the two supports of the nozzle ring assembly with a first housing member such that the two supports cannot rotate freely about a main axis of the variable geometry turbine relative to the first housing member; providing a shroud that defines a plurality slots and which is fixed to a second housing member such that the shroud cannot rotate freely about a main axis of the variable geometry turbine relative to the second housing member; engaging the nozzle ring assembly with the shroud such that each of the plurality of inlet vanes is received in a respective one of the plurality of slots; and fixing the first housing member to the second housing member such that the rotation of the nozzle ring about the main axis of the variable geometry turbine is not constrained by the two supports.

The nozzle ring may be a nozzle ring according to the first aspect of the present disclosure or the second aspect of the present disclosure. The two supports for a nozzle ring may each comprise a support according to the third aspect of the present disclosure. The nozzle ring assembly may be an assembly according to the fifth or sixth aspect of the present disclosure. The first housing member may be a bearing housing. The second housing member may be a turbine housing. The method according to the ninth aspect may be referred to as, or achieved using, a clocking process. An example of such a clocking process is disclosed in GB2578270, which is incorporated herein in its entirety by reference.

### BRIEF DESCRIPTION OF THE DRAWINGS

Specific embodiments of the present invention will now be described, by way of example, with reference to the accompanying drawings, of which:

FIG. 1 is a cross-section of a turbocharger incorporating a variable geometry turbine which could be fitted with a nozzle ring and nozzle ring supports in accordance with an embodiment of the present disclosure;

FIGS. 2A to 2C show three different views of nozzle ring that may form part of a turbocharger of the type shown in FIG. 1;

FIGS. 3A to 3D show four different views of a support for a nozzle ring that may form part of a turbocharger of the type shown in FIG. 1;

FIGS. 4A to 4D show the engagement between the nozzle ring shown in FIGS. 2A to 2C and the support shown in FIGS. 3A to 3D;

FIG. 5 shows an example cutting tool that may be used in a method of manufacturing the nozzle ring shown in FIGS. 2A to 2C;

FIGS. 6A to 6B show two different views of a first new nozzle ring which is a variant of the nozzle ring shown in FIGS. 2A to 2C and which may form part of a turbocharger of the type shown in FIG. 1;

FIGS. 7A to 7B show two different views of a second new nozzle ring which is a variant of the nozzle ring shown in FIGS. 2A to 2C and which may form part of a turbocharger of the type shown in FIG. 1;

FIG. 8A schematically shows a partial cross section of the nozzle ring shown in FIGS. 2A to 2C through the line 8A-8A that passes through one of the protrusions, as indicated in FIG. 2B, and a cutting tool of the form described above with reference to FIG. 5;

FIG. 8B schematically shows a partial cross section of the nozzle ring shown in FIGS. 7A to 7B through the line 8B-8B that passes through one of the protrusions, as indicated in FIG. 7B, and a cutting tool of the form described above with reference to FIG. 5;

FIGS. 9A to 9D show four different views of a new support for a nozzle ring which is a variant of the support shown in FIGS. 3A to 3D and which may form part of a turbocharger of the type shown in FIG. 1;

FIGS. 10A to 10E show the engagement between the nozzle ring shown in FIGS. 7A to 7B and the support shown in FIGS. 9A to 9D; and

FIG. 11 shows the engagement between the nozzle ring shown in FIGS. 6A to 6B and the support shown in FIGS. 3A to 3D.

### DETAILED DESCRIPTION OF THE DRAWINGS

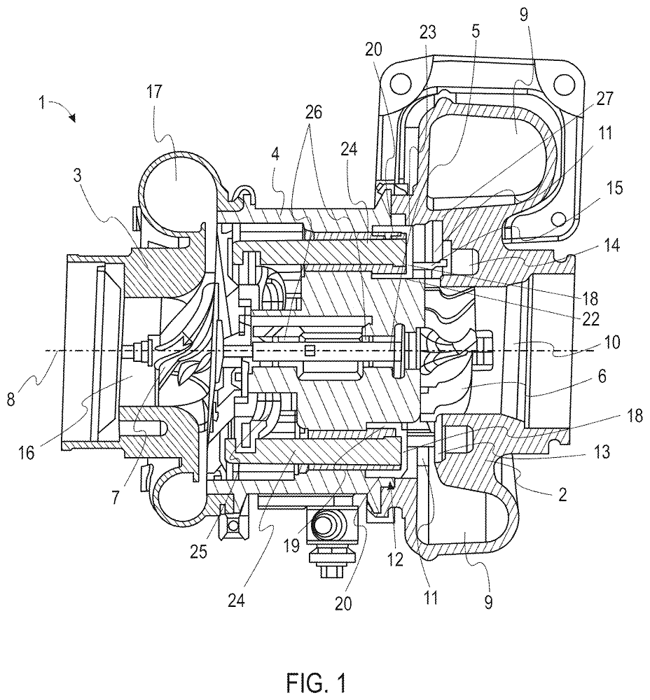

A turbocharger 1 incorporating a variable geometry turbine which could be fitted with a nozzle ring and nozzle ring supports in accordance with an embodiment of the present disclosure is now described with reference to FIG. 1.

FIG. 1 shows a turbocharger 1 incorporating a variable geometry turbine in accordance with an embodiment of the present disclosure. The turbocharger 1 comprises a turbine housing 2 and a compressor housing 3 interconnected by a central bearing housing 4. A turbocharger shaft 5 extends from the turbine housing 2 to the compressor housing 3 through the bearing housing 4. The shaft 5 is supported by two journal bearings 26. A turbine wheel 6 is mounted on one end of the shaft 5 for rotation within the turbine housing 2, and a compressor wheel 7 is mounted on the other end of the shaft 5 for rotation within the compressor housing 3. The shaft 5 rotates about turbocharger axis 8 on the bearings 26 located in the bearing housing 4.

It will be appreciated that the turbine housing 2 and an axial end of the bearing housing 4 together form a housing of the variable geometry turbine, in which the turbine wheel 6 is supported for rotation about turbocharger axis 8.

The turbine housing 2 defines an inlet volute 9 to which exhaust gas from an internal combustion engine (not shown) is delivered. The exhaust gas flows from the inlet volute 9 to an axial outlet passage 10 via an inlet passageway 11 and the turbine wheel 6. The inlet passageway 11 is defined between two axially spaced walls. In particular, the inlet passageway 11 is defined on one side by a face of a movable wall member 12, commonly referred to as a “nozzle ring,” and on the opposite side by a shroud 13. The shroud 13 covers the opening of a generally annular recess 14 in the turbine housing 2. The movable wall member 12 may be moveable between a fully open position and a fully closed position.

As will be appreciated by the skilled person, the inlet volute 9 may comprise a generally toroidal volume (defined by the turbine housing 2) and an inlet arranged to direct exhaust gas from an internal combustion engine tangentially into the generally toroidal volume. As exhaust gas enters the inlet volute 9 it flows circumferentially around the generally toroidal volume and radially inwards towards the inlet passageway 11. In the vicinity of the inlet, there is provided a wall or “tongue” 27 which serves to separate the generally toroidal volume in the vicinity of the inlet of the volute 9 from the inlet passageway 11 of the turbine. The tongue 27 may help to guide the exhaust gas circumferentially around the generally toroidal volume and may also aid the mixing of the generally linear gas flowing into the volute 9 with the circumferential gas flow around the generally toroidal volume.

The movable wall member 12 supports an array of circumferentially spaced inlet vanes 15 each of which extends across the inlet passageway 11. The vanes 15 are orientated to deflect gas flowing through the inlet passageway 11 towards the direction of rotation of the turbine wheel 6. The shroud 13 is provided with suitably configured slots for receipt of the vanes 15 such that as the movable wall member 12 moves axially towards the shroud 13, a distal end of each of the vanes 15 moves through one of said slots and protrudes into the recess 14.

Accordingly, by appropriate control of the actuator (which may for instance be pneumatic or electric), the axial position of the movable wall member 12 can be controlled. The speed of the turbine wheel 6 is dependent upon the velocity of the gas passing through the inlet passageway 11. For a fixed rate of mass of gas flowing into the inlet passageway 11, the gas velocity is a function of the width of the inlet passageway 11, the width being adjustable by controlling the axial position of the movable wall member 12. As the width of the inlet passageway 11 is reduced, the velocity of the gas passing through it increases.

Gas flowing from the inlet volute 9 to the outlet passage 10 passes over the turbine wheel 6 and as a result torque is applied to the shaft 5 to drive the compressor wheel 7. Rotation of the compressor wheel 7 within the compressor housing 2 pressurises ambient air present in an air inlet 16 and delivers the pressurised air to an air outlet volute 17 from which it is fed to an internal combustion engine (not shown).

The movable wall member (or nozzle ring) 12 comprises a generally annular wall 18 and radially inner and outer flanges 19, 20 extending axially from the generally annular wall 18.

A cavity 21 is provided in the housing of the variable geometry turbine for receipt of the radially inner and outer flanges 19, 20 of the moveable member 12. It will be appreciated that the cavity 21 is formed on an axial end of the bearing housing 4, which cooperates with the turbine housing 2 to form the housing of the variable geometry turbine.

As the movable wall member 12 moves axially, the extent to which the radially inner and outer flanges 19, 20 of the moveable member 12 are received in the cavity 21 varies. The moveable wall member 12 is moveable between a fully opened position and a fully closed position.

Inner and outer sealing rings 22 and 23 are provided to seal the movable wall member 12 with respect to inner and outer curved surfaces of the cavity 21 respectively, whilst allowing the movable wall member 12 to slide within the cavity 21. The inner sealing ring 22 is supported within an annular groove formed in a radially inner curved surface of the cavity 21 and bears against the inner flange 19 of the movable wall member 12. The outer sealing ring 23 is supported within an annular groove formed in a radially outer curved surface of the cavity 21 and bears against the outer flange 20 of the movable wall member 12.

The movable wall member 12 is supported by two supports 24. Each of the supports being generally of the form of a shaft or rod. The two supports 24 may be referred to as push rods. Each of the two supports 24 engages with to movable wall member 12, as discussed further below.

The supports 24 extend from the cavity 21 into the bearing housing 4 for connection to an actuation mechanism. The position of the movable wall member 12 is controlled by an actuator assembly, which may be generally of the type disclosed in U.S. Pat. No. 5,868,552. An actuator (not shown) is operable to adjust the position of the movable wall member 12 via a mechanical linkage. For example, an actuator may be connected by a lever system to a bar upon which a generally C-shaped yoke 25 is mounted. The ends of the generally C-shaped yoke engages with the two supports 24 via notches formed proximate a distal end of each of the two supports 24.

Embodiments of the present disclosure relate to a new engagement between a nozzle ring 12 and two supports 24 of the type shown in FIG. 1. In order to achieve this, some embodiments of the present disclosure relate to a nozzle ring 112 and some embodiments of the present disclosure relate to supports 124.

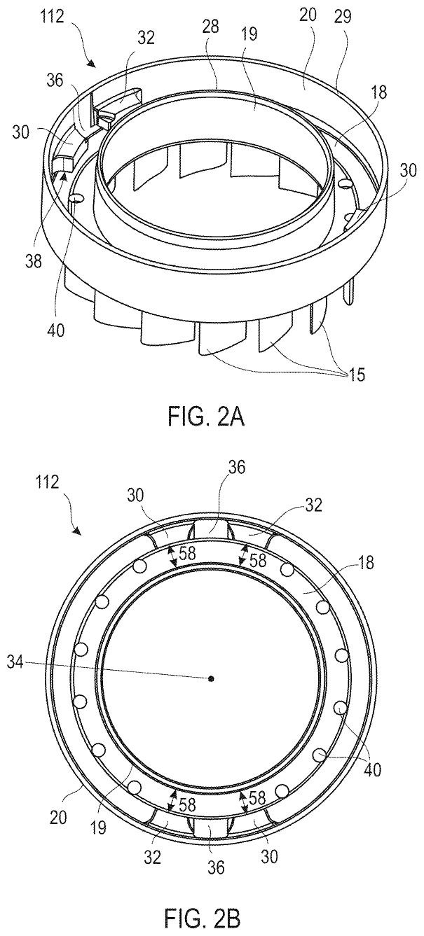

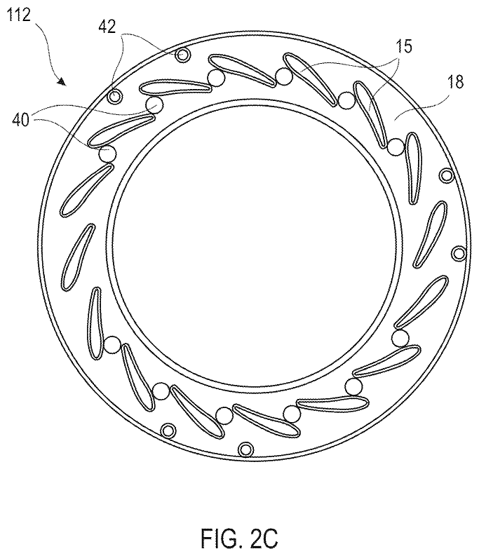

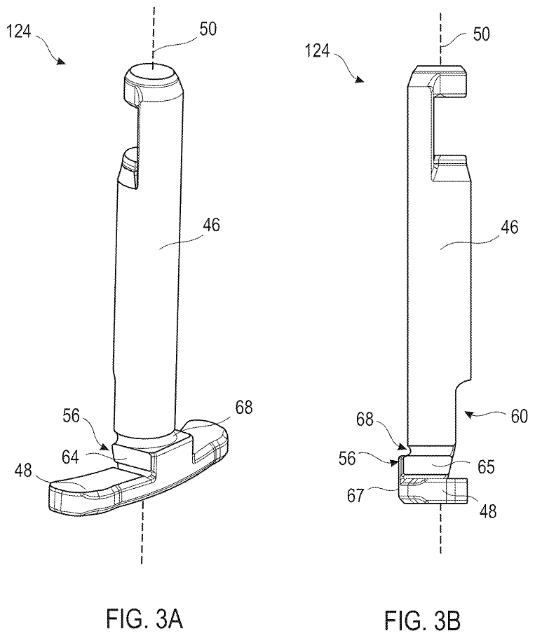

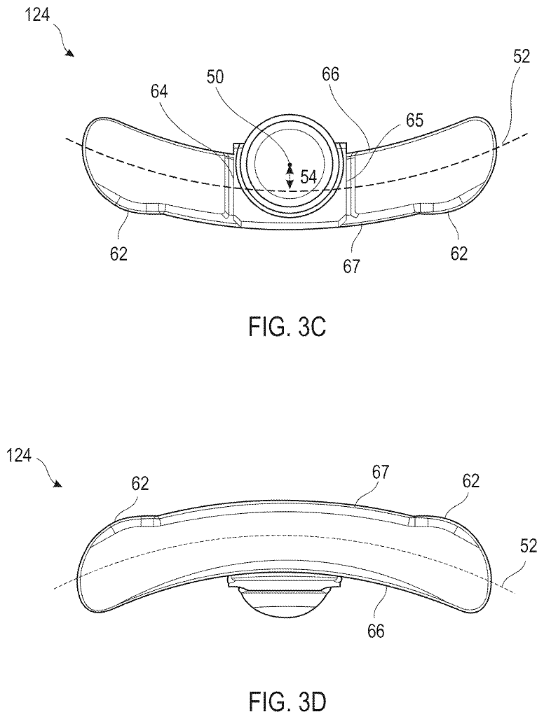

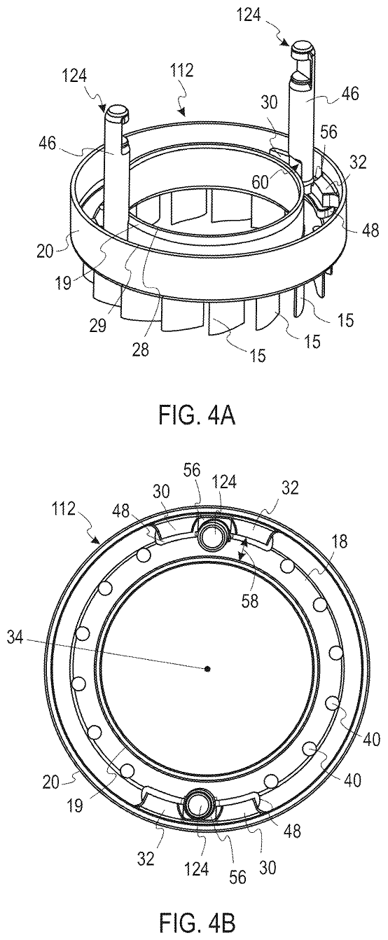

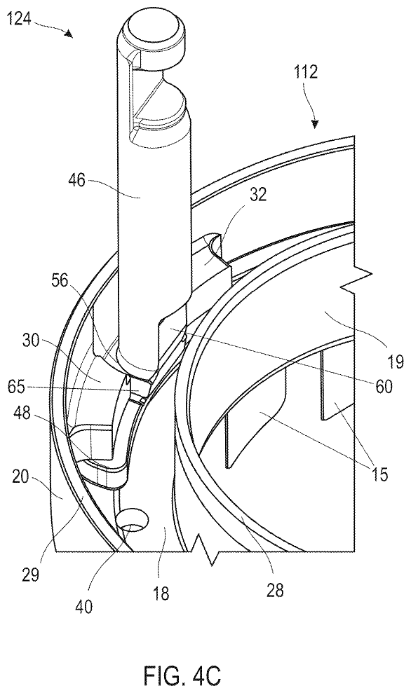

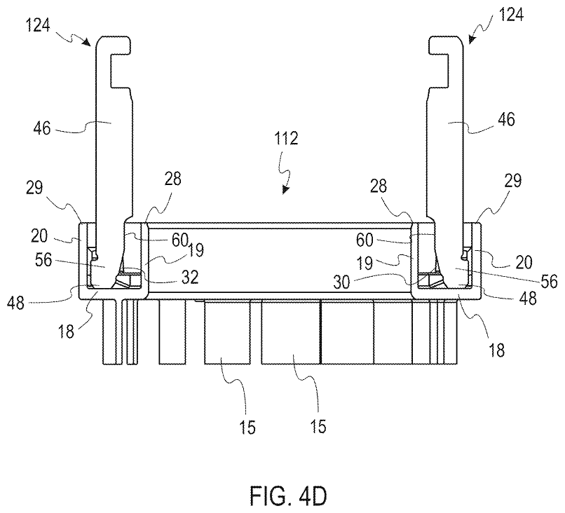

FIGS. 2A to 2C show three different views of the nozzle ring 112. FIGS. 3A to 3D show four different views of the support 124. FIGS. 4A to 4D show the engagement between the nozzle ring 112 and the supports 124.

The inner flange 19 that is generally perpendicular to the generally annular wall 18, extends from a radially inner edge of the generally annular wall 18 to a distal end 28 of the inner flange 19. Similarly, the outer flange 20 that is generally perpendicular to the generally annular wall 18, extends from a radially outer edge of the generally annular wall 18 to a distal end 29 of the outer flange 20.

The nozzle ring 112 further comprises two engagement features, each for engagement with one of the supports 124. Each engagement feature comprises two protrusions 130, 132 extending from one of the inner or outer flange 19, 20 partially towards the other one of the inner or outer flange 19, 20. The two protrusions 130, 132 may be considered to extend from one of the inner or outer flange 19, 20 partially towards the other one of the inner or outer flange 19, 20 in a plane generally parallel to the generally annular wall 18. In the embodiment shown in FIGS. 2A to 2C, the two protrusions 130, 132 of each engagement feature extend from the outer flange 20 partially towards the inner flange 19. It will be appreciated that in other embodiments, each engagement feature may comprise two protrusions extending from the inner flange 19 partially towards the outer flange 20.

It will be appreciated that an axis 134 of the nozzle ring 112 may be defined as an axis which is perpendicular to the generally annular wall 18 and which passes through a centre of the generally annular wall 18. Furthermore, when referring to features of the nozzle ring, the terms axial, radial and circumferential may be defined relative to this axis.

The two protrusions 130, 132 extend from a curved surface of the outer flange 20 towards the inner flange 19. The curved surface may be referred to as a side wall of the outer flange 20. Therefore, the two protrusions 130, 132 extend from an interior surface of the nozzle ring 112.

The two protrusions 130, 132 are integrally formed with the outer flange 20 (from which they extend). As used herein, integrally formed may mean that the material of the two protrusions 130, 132 and the material of the outer flange 20 (from which they extend) may be formed by a common manufacturing process. Additionally or alternatively, integrally formed may mean that there is no discernible join between the two protrusions 130, 132 and the outer flange 20 (from which they extend).

The inner and outer flanges 19, 20 extend further from the generally annular wall 18 than the two protrusions 130, 132. That is, the two protrusions 130, 132 do not extend axially further from the generally annular wall 18 than the inner and outer flanges 19, 20. For example, the two protrusions 130, 132 are each disposed at a position such that, in an axial direction, they are disposed entirely between the generally annular wall 18 and the distal ends 28, 29 of the inner and outer flanges 19, 20. A first gap 136 is defined between the two protrusions 130, 132. The first gap 136 may alternatively be referred to as a first recess 136. The first gap 136 is defined by a circumferential gap between the two protrusions 130, 132. A second gap 138 is defined between the generally annular wall 18 and both of the two protrusions 130, 132. The second gap 138 may alternatively be referred to as a second recess 138. The second gap 138 is defined by an axial gap between the generally annular wall 18 and the two protrusions 130, 132.

In this embodiment, a size of the axial gap between the generally annular wall 18 and each of the two protrusions 130, 132 is the same. That is, an axial dimension of the second gap 138 is generally uniform. It will be appreciated that in alternative embodiments, an axial gap between the generally annular wall 18 and the first protrusion 130 may differ an axial gap between the generally annular wall 18 and the second protrusion 132. That is, in alternative embodiments, an axial dimension of the second gap 138 may vary around a circumference of the nozzle ring 112.

The generally annular wall 18 supports an array of circumferentially spaced inlet vanes 15 each of which extends axially away from a surface of the generally annular wall 18 opposite from the inner and outer flanges 19, 20. As discussed above with reference to FIG. 1, in use, these vanes 15 extend across an inlet passageway 11 of a variable geometry turbine. The vanes 15 may be arranged to direct gas flowing through the inlet passageway 11 towards a direction of rotation of a turbine wheel 6 so as to improve efficiency of the turbine. In this embodiment, the inlet vanes 15 are equally spaced circumferentially on the generally annular wall 18. However, in other embodiments, different arrangements of the vanes 15 may alternatively be provided on the generally annular wall 18. As discussed further below, one advantage of some embodiments disclosed herein is that greater freedom is provided over the placement of vanes 15 on the generally annular wall 18.

As can be seen in FIGS. 2A to 2C, optionally, a plurality of axially extending apertures 140 may be provided through the generally annular wall 18 of the moveable wall member 112. The apertures 140 may be referred to as balancing apertures 140. In use, the apertures 140 connect the inlet 11 to the cavity 21, such that the inlet 11 and the cavity 21 are in fluid communication via the apertures 140. In use, the apertures 140 serve to reduce pressure differences across the generally annular wall 18 of the nozzle ring 112 and thereby reduce loads applied to the face of the generally annular wall 18 of the nozzle ring 112.

It will be appreciated that as gas flows through the inlet passageway 11 the pressure of the gas flow drops as it moves across the face of the nozzle ring 112 towards the turbine wheel 6. Therefore, by selecting a particular radial position for the balance apertures 140, an average pressure within the cavity 21 (which will be substantially equal to the local average pressure in the inlet 11 proximate to the balance apertures 140) can be maintained.

In use, as air flows radially inwards through the turbine inlet 11, it flows between adjacent vanes 15, which can be regarded as defining a vane passage. The turbine inlet 11 has a reduced radial flow area in the region of the vane passage with the effect that the inlet gas speed increases through the vane passage with a corresponding drop in pressure in this region of the movable wall member 112. In this embodiment, the balancing apertures 140 are located between pairs of adjacent vanes 15 in the sense that the inner and outer radial extremity of these balancing apertures 112 lie within the inner or outer radial extent of the vane passage.

In addition, in alternative embodiments, optionally, a smaller number of additional balancing apertures (not shown) may be provided upstream of (i.e. at a larger radius than) the balance apertures 140 located between pairs of adjacent vanes 15. These additional balance apertures (not shown) can result in a reduction in the force amplitude at the actuator interface caused by an exhaust pulse passing through the inlet passageway 11 when compared with the provision of the balance apertures 140 located between pairs of adjacent vanes 15 alone.

As discussed further below, one advantage of some embodiments disclosed herein is that greater freedom is provided over the placement of balancing apertures 140 and additional balancing apertures on the generally annular wall 18.

Optionally, a plurality of protrusions 142 are provided on the movable wall member 112. Each of these protrusions 142 extends axially away from the same surface of the generally annular wall 18 as the inlet vanes 15 (i.e. the surface opposite from the inner and outer flanges 19, 20). A distal end of each of these protrusions 142 may be arranged to contact the shroud 13 when the movable wall member 112 is at one end of its range of axial movement. That is, each of these protrusions 142 may provide a physical stop to define one end of the range of axial movement of the movable wall member 112. This prevents the generally annular wall 18 from contacting the shroud 13 directly, which may be desirable.

The support 124 for the nozzle ring 112 comprises a body, the body comprising: an elongate generally cylindrical portion 146; and an arcuate head portion 148. The arcuate head portion 148 is disposed adjacent one end of the generally cylindrical portion 146. The head portion 148 extends generally perpendicular to an axis 150 of the generally cylindrical portion 146. The generally cylindrical portion 146 may be supported in a bush or the like on the bearing housing 4 for linear movement relative to said bearing housing 4.

Although in this embodiment the elongate portion 146 is generally cylindrical, in alternative embodiments the elongate portion 146 may have a different cross sectional shape.

As can be best seen in FIG. 3C, a bisector 152 of the arcuate head portion 148 in a plane perpendicular to the axis 150 of the generally cylindrical portion 146 is offset from said axis 150 by an offset 154.

The nozzle ring 112 of the type shown in FIGS. 2A-2C and 4A-4D is advantageous over other known arrangements, as now discussed. As will be discussed further below, the nozzle ring 112 may be supported by two supports 124 extending parallel to the axis 134 of the nozzle ring 112 and may be moved by an actuator that axially displaces the rods 124. The two rods are disposed on the same side of the nozzle ring 112 as the inner and outer flanges 19, 20.

In use, the supports 124 partially extend through a bearing housing 4 that may be cooled whereas the nozzle ring 112 may be exposed to hot exhaust gases that are used to drive the turbine wheel 6 and will therefore be subject to significant thermal expansion and contraction during use. Since the housing 4 is provided with cooling, a spacing between the supports 124 may vary significantly less than a diameter of the nozzle ring 112 supported by the supports 124 in response to operating temperature changes. In efforts to address this problem, variable geometry turbines have been developed in which the nozzle ring is connected to its supports using a linkage mechanism which allows for limited relative movement in the radial direction. The allowed movement should be sufficient to accommodate the maximum expected differential expansion, but limited so that the mechanism is still able to position the nozzle ring 112 accurately in the housing. In addition to the operating requirements mentioned above, the interconnections between the nozzle ring and the supports should prevent excessive tilting of the nozzle ring relative to a plane perpendicular to the supports as this would affect the operating clearances of the linkage mechanism and thereby reduce performance. The nozzle ring should also be accurately positioned in the axial direction to ensure that the mechanism responds in a predictable manner to a control input. This means that the mechanism should have limited backlash to ensure proper operation and control. All this has to be achieved in a linkage mechanism that is robust enough to last for several thousands of hours running in the corrosive exhaust gas of an engine, at high temperatures, with no lubrication and in conditions in which mechanical vibration of the interconnected components is inevitable. Such performance has proved difficult to achieve.

In some existing variable geometry turbochargers, two rods that support a nozzle ring are connected to the nozzle ring using rivets. One example arrangement is disclosed in U.S. Pat. No. 6,401,563. The nozzle ring supports a limiting stop and a cylindrical pivot for connection to each rod. A transverse elongate element is secured to one end of each rod and defines a pair of bores arranged to be aligned with the stop and pivot. The stop and pivot are secured to the ring by washers and rivets, with the transverse element retained between the ring and the washers. The pivot is a close fit in its respective bore, whereas the stop is a loose fit in its bore. Accordingly the transverse element can rotate on the pivot to an extent determined by the clearance between the stop and the wall of its bore when, during operation, the ring expands more than the housing supporting the rods. Thus, increased radial expansion of the ring as compared to the rods is accommodated by each transverse element pivoting radially inwardly.

The arrangement disclosed in U.S. Pat. No. 6,401,563 involves a number of technical challenges. First, the locations of the rivet heads on the generally annular wall restrict the possible arrangements of vanes supported thereby since the vanes need to be arranged such that they do not coincide with the position of any of the rivet heads. Second, the process of riveting can lead to some distortion of vanes, especially those disposed adjacent the rivet heads. Third, rivets may be prone to wear and cracking. Fourth, the connection of each supporting rod to the nozzle ring involves a significant number of parts which need to be accurately assembled. Fifth, the use of rivets results in a permanent or semi-permanent assembly.

The nozzle ring 112 of the type shown in FIGS. 2A-2C and 4A-4D is advantageous, as now discussed. The two protrusions 130, 132 provide a feature for engagement with a support 124. In particular, as shown in FIGS. 4A to 4D, the arcuate head portion 148 of the support 124 may be received in the second gap 138 between the generally annular wall 18 and the two protrusions 130, 132. An axial dimension of the arcuate head portion 148 may generally match an axial dimension of the second gap 138 between the generally annular wall 18 and the two protrusions 130, 132. A small axial clearance between the arcuate head portion 148 and the nozzle ring 112 may be provided to allow for differential thermal expansion of the nozzle ring 112 and the supports 124 whilst still providing accurate control over a position of the nozzle ring in use. With such an arrangement, axial movement of the supports 124 in either direction will cause the nozzle ring 112 to move axially.

An intermediate portion 156 of the support 124 between the arcuate head portion 148 and the generally cylindrical portion 146 is, in use, received in the first gap 136 between the two protrusions 130, 132. By minimising a clearance between the two protrusions 130, 132 and the intermediate portion 156 of the support 124 any torque applied to the nozzle ring 112 can be carried by the surfaces of the two protrusions 130, 132 that define the first gap 136.

The intermediate portion 156 defines two parallel surfaces 164, 165. In use, the intermediate portion 156 is received in the first gap 136 of the nozzle ring 112 (between the two protrusions 130, 132). In use, the two parallel surfaces 164, 165 may each be adjacent a surface of one of the two protrusions 130, 132.

The intermediate portion 156 extends radially outboard of the generally cylindrical portion 146.

The body of the support body further comprises: a reduced diameter portion 168 disposed between the intermediate portion 156 and the elongate generally cylindrical portion 146. The reduced diameter portion 168 is radially inboard of the generally cylindrical portion 146. In the shown example, the reduced diameter portion 168 is provided by a groove formed on the elongate generally cylindrical portion 146. Advantageously, this can prevent the intermediate portion 156 from contacting a bush or the like which supports the elongate generally cylindrical portion 146 in use. Additionally, this reduced diameter portion 168 can prevent the intermediate portion 156 from contacting a finishing tool used to finish a surface of the elongate portion 146.

The two protrusions 130, 132 only extend partially from one of the inner or outer flange 19, 20 towards the other one of the inner or outer flange 19, 20. That is, the two protrusions 130, 132 only extend radially partially from one of the inner or outer flange 19, 20 towards the other one of the inner or outer flange 19, 20 such that there is a radial gap 158 defined between distal ends of the two protrusions 19, 20 and the other one of the inner or outer flange 19, 20. This allows the supporting rod 124 to be engaged with the nozzle ring 112 as follows. First, the arcuate head portion 148 of the supporting rod 124 is aligned radially with the radial gap 158 defined between distal ends of the two protrusions 130, 132 and the other one of the inner or outer flange 19, 20. Next, the supporting rod 124 is moved axially towards the generally annular wall 18. Once the arcuate head portion 148 of the supporting rod 124 is adjacent the generally annular wall 18, the supporting rod 124 is moved radially towards the two protrusions 130, 132 until: (a) the arcuate head portion 148 is received in the second gap 138 (between the generally annular wall 18 and the two protrusions 130, 132); and (b) the intermediate portion 156 of the supporting rod 124 is received in the first gap 136 (between the two protrusions 130, 132).

In this embodiment, both of the two protrusions 130, 132 only extend radially partially from the outer flange 20 towards the inner flange 19 such that there is a radial gap defined between distal ends of both of the two protrusions 130, 132 and the inner flange 20. In some alternative embodiments, only one of the two protrusions 130, 132 extends only partially from one of the inner or outer flange 19, 20 towards the other one of the inner or outer flange 19, 20 (and the other one of the two protrusions extends fully from one of the inner or outer flange 19, 20 towards the other one of the inner or outer flange 19, 20). For such alternative embodiments, the supporting rod 124 can be engaged with the nozzle ring 112 as follows. First, the arcuate head portion 148 of the supporting rod 124 is aligned radially with the radial gap defined between a distal end of the one protrusion that extends only partially between the inner and outer flanges 19, 20 and the other one of the inner or outer flange 19, 20. Next, the supporting rod 124 is moved axially towards the generally annular wall 18. Once the arcuate head portion 148 of the supporting rod is adjacent the generally annular wall 18, the supporting rod 124 is moved circumferentially until: the intermediate portion 156 of the supporting rod 124 is aligned with the first gap 136 (between the two protrusions). Next, the supporting rod 124 is moved radially towards the two protrusions until: (a) the arcuate head portion 148 is received in the second gap 138 (between the generally annular wall 18 and the two protrusions); and (b) the intermediate portion 156 of the supporting rod 124 is received in the first gap 136 (between the two protrusions).

The nozzle ring 112 provides a simple arrangement that allows for engagement with a supporting rod 124 that does not use rivets. Advantageously, this avoids the problems associated with riveted arrangements, as discussed above. In particular, since there are no rivets on the generally annular wall 28, there is, in general, greater design freedom for the placement of vanes 15 and/or balance apertures 140 on the generally annular wall 18. Furthermore, the connection of the supporting rods 124 to the nozzle ring 112 is less involved and uses fewer parts. Furthermore, the nozzle ring 112 can be more easily disengaged from the supporting rods 124, which may facilitate easier replacement of only one of these parts (rather than the whole permanent or semi-permanent assembly) as desired.

Furthermore, the nozzle ring 112 is advantageous over existing arrangements that do not use rivets.

One example previous arrangement that does not use rivets to connect the nozzle ring to the support rods comprises an additional annular plate that is attached by welding or the like to ends of the radially inner and outer flanges that are distal to the generally annular wall. Therefore, the additional annular plate closes a face of the nozzle ring which is opposite the generally annular wall. The additional annular plate and, optionally, the inner or outer flange is provided with features for engagement with a head portion of the support rods.

Therefore, the existing arrangement that does not use rivets uses an additional annular plate and the provision of features for engagement with the head portion of the support rods. Both the additional annular plate and the engagement features extend the axial length of the nozzle ring assembly. This increased axial length needs to be accommodated in the turbine, potentially increasing an axial extent of the turbine. In contrast, since the nozzle ring 112 of this disclosure is provided with two protrusions 130, 132 from one of the inner or outer flange 19, 20, the second gap 138 (which is for receipt of the arcuate head portion 148 of a support rod 124) is partially defined by the generally annular wall 18. Therefore, in use, the arcuate head portion 148 of the support rods 124 is disposed adjacent to the generally annular wall 18, within a cavity formed by the generally annular wall 18 and the inner and outer flanges 19, 20. Advantageously, this results in an axially compact arrangement.

Since the nozzle ring 112 is provided with two protrusions 130, 132 from one of the inner or outer flange 19, 20, rather than an annular plate that must be welded onto the distal ends 28, 29 of the radially inner and outer flanges 19, 20, it uses less material and is therefore less costly to manufacture than the existing arrangements that do not use rivets. In addition, the use of two protrusions 130, 132 from one of the inner or outer flange 19, 20, rather than an annular plate that must be welded onto the distal ends 28, 29 of the radially inner and outer flanges 19, 20, advantageously involves fewer manufacturing steps. Furthermore, the nozzle ring 112 is easier and less costly to assemble with one or more supporting rods 124 than the existing arrangement that does not use rivets.

In use, the elongate generally cylindrical portion 146 of the support 124 may be supported in a bush or the like on a housing (for example bearing housing 4 shown in FIG. 1) for linear movement relative to said housing.

As discussed above, the bisector 152 of the arcuate head portion 148 in a plane perpendicular to the axis 150 of the generally cylindrical portion 146 is offset from said axis 150. That is, in a plane perpendicular to the axis 150 of the generally cylindrical portion 146, a centre of the arcuate head portion 148 is radially offset from a centre of the generally cylindrical portion 146. Advantageously, such an arrangement allows the support 124 to be engaged with the nozzle ring 112 as described above such that, once the support 124 is engaged with the nozzle ring 112, the axis 150 of the generally cylindrical portion 146 is disposed generally centrally between the inner and outer flanges 19, 20 of the nozzle ring. This may facilitate the retrofitting of the nozzle ring 112 and supports 124 of the type shown in FIGS. 2A to 4D to a known variable geometry turbine.

It may be generally desirable to maximise a radial extent of the two protrusions 130, 132 between the inner flange and the outer flange 19, 20. However, it will be appreciated that this maximization may be subject to the following constraints. First, in order to engage a support 124 with the two protrusions 130, 132 of the nozzle ring 112, as explained above, an arcuate head portion 148 of the supporting rod 112 may be aligned radially with the radial gap 158 defined between distal ends of the two protrusions 130, 132 and the other one of the inner or outer flange 19, 20 and then moved axially towards the generally annular wall 18 through this radial gap 158. It will be appreciated that this may impose a maximum radial extent of at least one of the two protrusions 130, 132 between the inner flange and the outer flange. Second, in some embodiments, the second gap 138 (defined between the generally annular wall 18 and the two protrusions 130, 132) may be at least partially formed and/or finished using a cutting tool having a cutting portion that moves axially through the radial gap 158 defined between distal ends of the two protrusions 130, 132 and the other one of the inner or outer flange 19, 20 and then radially towards the two protrusions 130, 132 to form or finish the second gap 138. Again, allowing for sufficient space for the cutting portion and any support therefor may impose a maximum radial extent of the two protrusions 130, 132 between the inner flange and the outer flange 19, 20. In some embodiments, the protrusions 130, 132 may be finished and/or formed using electrochemical machining. For such embodiments, the two protrusions 130, 132 may be finished without the use of a cutting tool and therefore the constraint imposed by a cutting tool may not apply.

In some embodiments, the radial extent of the two protrusions 130, 132 may be between 0.25 and 0.5 times the radial distance between the inner flange and the outer flange 19, 20. In some embodiments, the radial extent of the two protrusions 130, 132 may be between 0.3 and 0.5 times the radial distance between the inner flange and the outer flange 19, 20. In some embodiments, the radial extent of the two protrusions 130, 132 may be between 0.35 and 0.45 times the radial distance between the inner flange and the outer flange 19, 20. In the example embodiment shown in FIGS. 2A to 4D, the radial extent of the two protrusions 130, 132 is around 0.42 times the radial distance between the inner flange and the outer flange 19, 20.

As best shown in FIG. 3B, a recess 160 is defined on the end of the elongate generally cylindrical portion 146 adjacent the arcuate head portion 148. The recess 160 is defined on a side of the generally cylindrical portion 146 opposite to a direction in which the bisector 152 of the arcuate head portion 148 is offset from the axis 150 of the elongate generally cylindrical portion 146 (in the plane perpendicular to said axis 150).

The recess 160 defined on a side of the generally cylindrical portion 146 may receive one of the inner and outer flanges 19, 20 of the nozzle ring 112 during engagement of the support 124 with the nozzle ring 112. For example, in the shown embodiment, the recess 160 defined on a side of the generally cylindrical portion 146 may receive the inner flange 19 of the nozzle ring 112 as the arcuate head portion 148 of the support 124 is moved axially towards the generally annular wall 18 of the nozzle ring 112 (before it is moved radially towards the two protrusions 130, 132).

The arcuate head portion 148 defines two opposed curved surfaces 166, 167. At least one of the two opposed curved surfaces 166, 167 defines one or more anti-wear protrusions 162 therefrom, as now discussed.

The two anti-wear protrusions 162 are defined on a surface 167 that, in use, is adjacent the outer flange 20 of the nozzle ring 112. Such protrusions 162 may, in use, contact a surface of outer flange 20 of the nozzle ring 112.

The two protrusions 162 are each disposed proximate a different end of the arcuate head portion 148.

The two opposed curved surfaces 166, 167 of the arcuate head portion 148 may have a curvature that generally matches the inner and/or outer flange 19, 20 of the nozzle ring 112. In use, one of the two opposed curved surfaces 167 of the arcuate head portion 148 is disposed adjacent the outer flange 20 (from which the two protrusions 130, 132 extend). A small clearance provided between the two protrusions 130, 132 of the nozzle ring 112 and the intermediate portion 156 of the support 124 allows for different thermal expansion of the nozzle ring 112 (relative to the two supports 124). Any torque applied to the nozzle ring 112 is carried by the surfaces of the two protrusions 130, 132 that define the first gap 136. The torque applied to the nozzle ring 112 will result in contact between the nozzle ring 112 and the support 124 and will tend to rotate the support 124 about the axis 150 of the elongate portion 146. In use, relative (radial) movement of the nozzle ring 112 and the support 124 can result in wear, which may undesirably increase the clearance between the two protrusions 130, 132 of the nozzle ring 112 and the intermediate portion 156 of the support 124. In use, the anti-wear protrusions 162 from one arcuate surfaces 167 of the arcuate head portion 148 may contact an adjacent surface of the outer flange 20 of the nozzle ring 112. Such protrusions 162 reduce a contact area between the arcuate head portion 148 and the outer flange 20 of the nozzle ring 112. Advantageously, it has been found that this can reduce relative movement of the support 124 and the nozzle ring 112 and therefore reduces wear of the support 124 and the nozzle ring 112.

According to some embodiments of the present disclosure, there is provided a method of manufacturing a nozzle ring 112 for a variable geometry turbine. The method may comprise forming a manufacturing intermediate, which is substantially the same form as the nozzle ring 112 described above except that there is no second gap 138 defined between the two protrusions 130, 132 and the generally annular wall 18. That is, the protrusions 130, 132 extend from the generally annular wall 18 partially towards the distal ends 28, 29 of the inner and outer flanges 19, 20. The method may further comprise finishing or machining the manufacturing intermediate to form the second gap 138 between the generally annular wall 18 and the protrusion 130, 132 so as to form the nozzle ring 112. The manufacturing intermediate may be formed by a casting process.

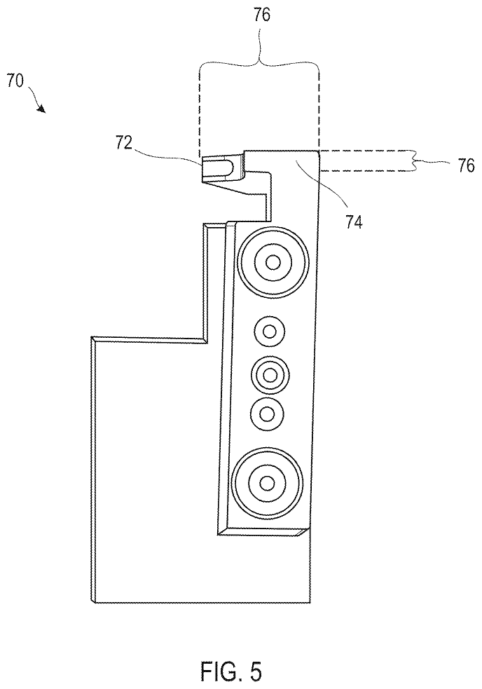

The finishing or machining of the manufacturing intermediate may be achieved as a turning process by rotating the manufacturing intermediate about its axis while a cutting portion of a cutting tool is moved radially outwards to form the second gap 138. An example of suitable cutting tool 70 is shown in FIG. 5. The second gap 138 (defined between the generally annular wall 18 and the two protrusions 130, 132) may be at least partially formed and/or finished using the cutting tool 70, as follows. The cutting tool 70 comprises a cutting portion 72 and a support portion 74 that together define a head portion 76 of the cutting tool 70. The head portion 76 is moved axially through the radial gap 158 defined between distal ends of the two protrusions 130, 132 and the other one of the inner or outer flange 19, 20. The head portion 76 is then moved radially towards the two protrusions 130, 132 such that the cutting portion 72 forms or finishes the second gap 138.

Alternatively, finishing of machining of the manufacturing intermediate may be achieved by electrochemical machining.

Optionally, the method of forming the nozzle ring 112 may further comprise finishing or machining a manufacturing intermediate to at least partially form the first gap 136 between two protrusions 130, 132 that extend from one of the inner or outer flange 19, 20 partially towards the other one of the inner or outer flange 19, 20.

In the above-described embodiments, the nozzle ring 112 comprises two discrete engagement features (each comprising a pair of protrusions 130, 132). In some alternative embodiments, one of the protrusions of the first engagement feature may be integrally formed with one of the protrusions of the second engagement feature. In some embodiments, each of the first set of protrusions may be integrally formed with a different one of the second set of protrusions. For example, referring to FIG. 2B, a first protrusion 130 of the engagement feature at the top of FIG. 2B may be integrally formed with a second protrusion 132 of the engagement feature at the bottom of FIG. 2B. Similarly, a second protrusion 132 of the engagement feature at the top of FIG. 2B may be integrally formed with a first protrusion 130 of the engagement feature at the bottom of FIG. 2B. Such an embodiment may use more material than the above-described embodiment, however, it may make the manufacturing process simpler.

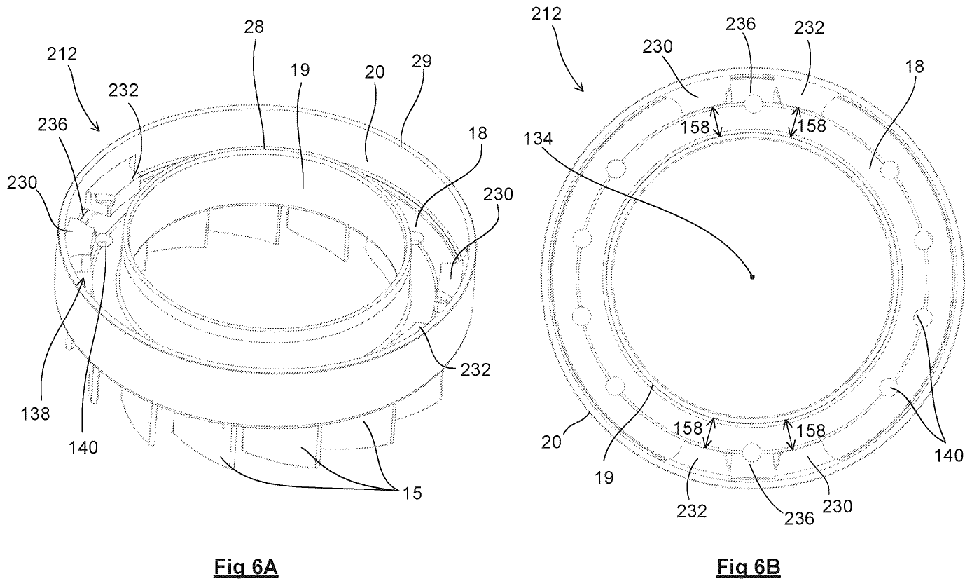

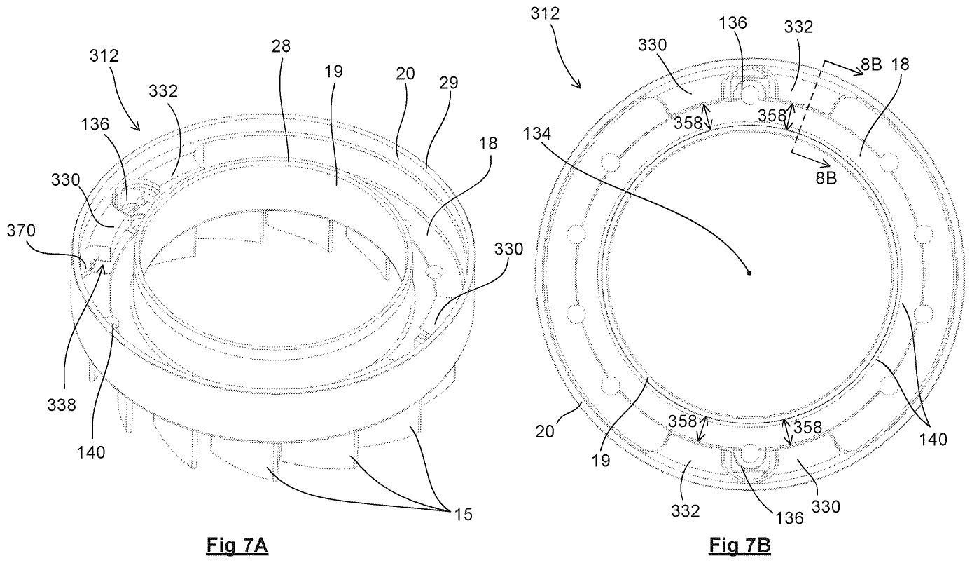

The nozzle ring 112 shown in FIGS. 2A to 2C and 4A to 4D is disclosed in an earlier patent application, GB2111046.5, which was unpublished at the priority date of the present application. Some embodiments of the present invention relate to new nozzle rings that are generally of the form of, but are variants of, the nozzle ring 112 shown in FIGS. 2A to 2C and 4A to 4D. FIGS. 6A to 6B show two different views of a new nozzle ring 212 that is a variant of the nozzle ring 112 shown in FIGS. 2A to 2C and 4A to 4D. FIGS. 7A to 7B show two different views of a new nozzle ring 312 that is a variant of the nozzle ring 112 shown in FIGS. 2A to 2C and 4A to 4D.

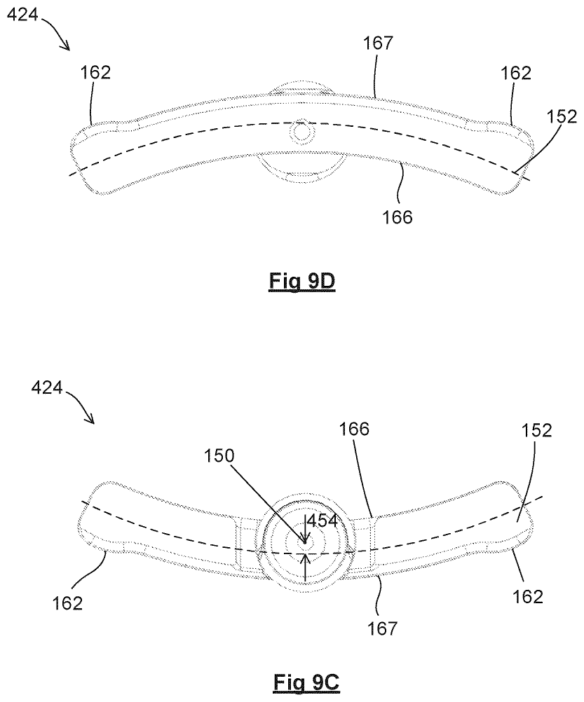

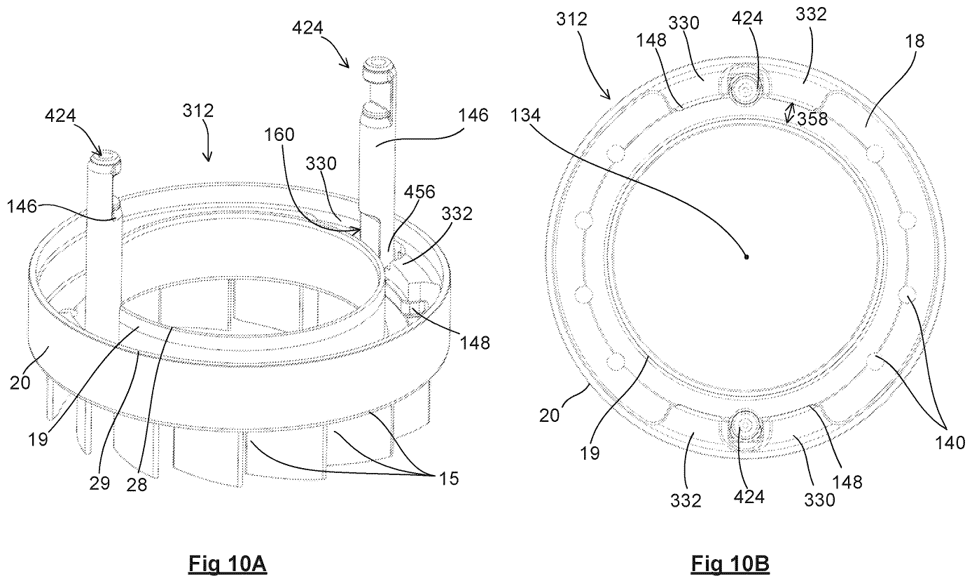

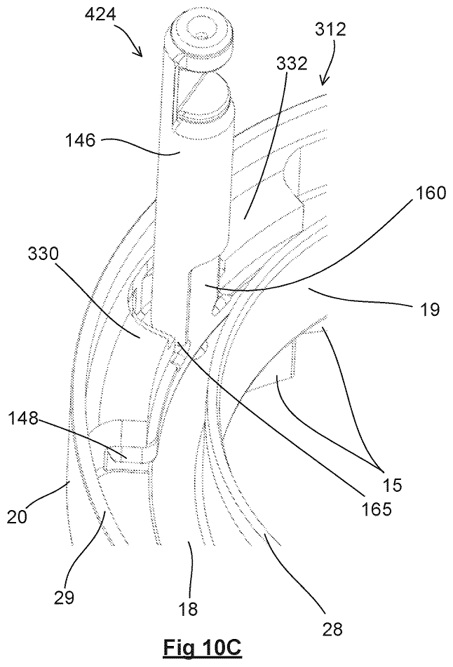

The supports 124 shown in FIGS. 3A to 3D and 4A to 4D is disclosed in an earlier patent application, GB2111046.5, which was unpublished at the priority date of the present application. Some embodiments of the present invention relate to new support for a nozzle ring that is generally of the form of, but is a variant of, the support 124 shown in FIGS. 3A to 3D and 4A to 4D. FIGS. 9A to 9D show four different views of a new support 424 that is a variant of the support 124 shown in FIGS. 3A to 3D and 4A to 4D.

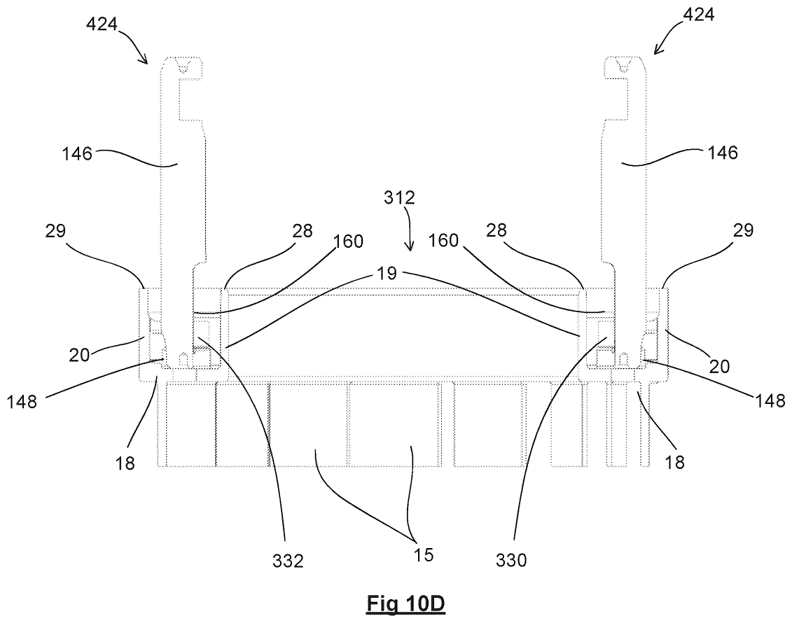

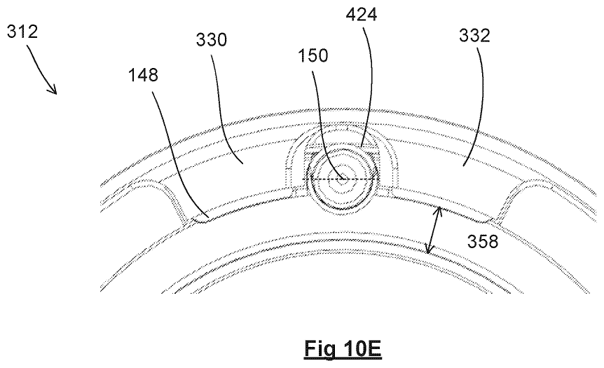

FIGS. 10A to 10D show the engagement between the nozzle ring 312 shown in FIGS. 7A to 7B and the supports 424 shown in FIGS. 9A to 9D.

The two new nozzle rings 212, 312 shown in FIGS. 6 and 7 are advantageous over existing arrangements that use rivets for the reasons discussed above with reference to FIGS. 2 to 4. In addition, the two new nozzle rings 212, 312 shown in FIGS. 6 and 7 can be more easily combined (than the arrangements shown in FIGS. 2A to 4D) with the conformal vanes and slots (and the associated advantage of improved turbine stage efficiency) taught in GB2555872, as now discussed.

In order to achieve a rivetless nozzle ring that can benefit from the advantages of conformal vanes and slots, sufficient clearance should be provided between the nozzle ring 112, 212, 312 and the support rods 124, 424 such that the nozzle ring is never, in use, rotationally constrained by the support rods. The inventors have realized that, in use, each of the support rods 124, 424 will rotate about the axis of the cylindrical portion (that is received in a guide bush in, for example, the bearing housing 4) freely until it contacts the nozzle ring 112, 212, 312. Furthermore, if the first gap 136 and the intermediate portion 156 of the support rod 124 received therein are each defined by two parallel surfaces 164, 165, such rotation will reduce a clearance between the support rods and the nozzle ring. In effect, the two parallel surfaces 164, 165 of the intermediate portion 156 mean that the clearance between the nozzle ring and the support rods is dependent on the rotation of the support rods. As a result, in order to ensure that the nozzle ring will never be rotationally constrained by the push rods a further increased clearance would be required between the nozzle ring and the support rods.

In practice, the axis 150 of the support rods will be at a radial position that is intermediate the inner flange 19 and the outer flange 20, for example close to halfway between the inner flange 19 and the outer flange 20.

FIGS. 6A to 6B show two different views of a new nozzle ring 212 that is a variant of the nozzle ring 112 shown in FIGS. 2A to 2C and 4A to 4D. Features that are common to the new nozzle ring 212 of FIGS. 6A to 6B and the nozzle ring 112 shown in FIGS. 2A to 2C and 4A to 4D and which are substantially unchanged share common reference numerals. Features of the new nozzle ring 212 of FIGS. 6A to 6B which differ from corresponding features of the nozzle ring 112 shown in FIGS. 2A to 2C and 4A to 4D have a reference numeral which is incremented by 100 relative to the corresponding features of the nozzle ring 112 shown in FIGS. 2A to 2C and 4A to 4D. In the following only the differences between the new nozzle ring 212 of FIGS. 6A to 6B and the nozzle ring 112 shown in FIGS. 2A to 2C and 4A to 4D are described in detail. It will be appreciated that the new nozzle ring 212 of FIGS. 6A to 6B may have any of the features, functionality or advantages of the nozzle ring 112 shown in FIGS. 2A to 2C and 4A to 4D and as described above, as appropriate.

The main difference between the new nozzle ring 212 of FIGS. 6A to 6B and the nozzle ring 112 shown in FIGS. 2A to 2C and 4A to 4D is that the shape of the two protrusions 230, 232 is different. In turn, this results in different shape of the first gap 236. In particular, the two protrusions 230, 232 are such that the first gap 236 is tapered so that a dimension of the first gap 236 is smaller at a distal end of the protrusions 230, 232 and larger proximate to the outer flange 20 (from which the two protrusions 230, 232) extend. In some embodiments, the new nozzle ring 212 of FIGS. 6A to 6B is used in combination with supports 124 of the type shown in FIGS. 3A to 3D and 4A to 4D and described above.

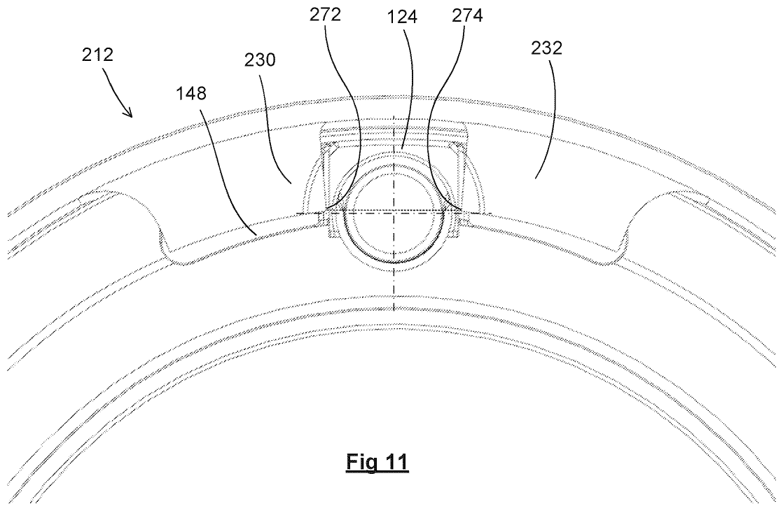

With such an arrangement, the first gap 236 may be sufficiently tapered such that the distal end of the protrusions 230, 232 can provide a physical stop that limits relative rotational movement of the nozzle ring 212 relative to the support rods 124. That is, it is the distal end of the protrusions 230, 232 that defines the clearance between the nozzle ring 212 and the support rods 124. Furthermore, the distal end of the protrusions 230, 232 will, in use, be close to a centre line of the cylindrical portion of the support rods. This can be best seen in FIG. 11, in which a centre line of the cylindrical portion of a support rod 124 is shown as a dot-dash line and a line between the two portions 272, 274 of the nozzle ring 212 that define an angular clearance between the support 124 rod and the nozzle ring 212 is shown as a dotted line. Advantageously, this limits the amount of additional clearance that should be provided to accommodate rotation of the support rods 124 about their axes 150. The first gap 236 being tapered avoids the need for an excessively large clearance to be provided between the nozzle ring 212 and the support rods 124. This is advantageous since such large clearances between the nozzle ring 212 and the support rods 124 may lead to performance variability. The closer the distal end of the protrusions 230, 232 are to the centre line ?? of the cylindrical portion 146 of the support rods 124, the smaller will be the dependence of the clearance between the nozzle ring 212 and the support rods 124 on the rotation of the support rods 124 about their axes 150.

In some embodiments the surfaces of each of the two protrusions 230, 232 that define the first gap 236 may be inclined relative to each other by any angle. In some embodiments, the surfaces of each of the two protrusions 230, 232 that define the first gap 236 are inclined relative to each other by an angle that is sufficient to accommodate the typical range of rotation of the supports 124 of the nozzle ring 212 in normal use.

In some embodiments the surfaces of the two protrusions 230, 232 that define the first gap 236 are inclined relative to each other by at least 8 degrees so as to provide the tapered first gap 236. The surfaces of each of the two protrusions 230, 232 that define the first gap 236 may be inclined at an angle of at least 4 degrees, for example at least 5 degrees such that the surfaces of the two protrusions 230, 232 are inclined relative to each other by at least 8 degrees, for example at least 10 degrees.

The new nozzle ring 212 shown in FIGS. 6A and 6B may, for example, be combined with the support 124 shown in FIGS. 3A to 3D and described above. Such an assembly is described below with reference to FIG. 11. Alternatively, the new nozzle ring 212 shown in FIGS. 6A and 6B may be combined with the new support 424 shown in FIG. 9A to 9D and described below, wherein a portion of the support 424 received in the first gap 336 is generally cylindrical.

FIGS. 7A to 7B show two different views of a new nozzle ring 312 that is a variant of the nozzle ring 112 shown in FIGS. 2A to 2C and 4A to 4D. Features that are common to the new nozzle ring 312 of FIGS. 7A to 7B and the nozzle ring 112 shown in FIGS. 2A to 2C and 4A to 4D and which are substantially unchanged share common reference numerals. Features of the new nozzle ring 312 of FIGS. 7A to 7B which differ from corresponding features of the nozzle ring 112 shown in FIGS. 2A to 2C and 4A to 4D have a reference numeral which is incremented by 200 relative to the corresponding features of the nozzle ring 112 shown in FIGS. 2A to 2C and 4A to 4D. In the following only the differences between the new nozzle ring 312 of FIGS. 7A to 7B and the nozzle ring 112 shown in FIGS. 2A to 2C and 4A to 4D are described in detail. It will be appreciated that the new nozzle ring 312 of FIGS. 7A to 7B may have any of the features, functionality or advantages of the nozzle ring 112 shown in FIGS. 2A to 2C and 4A to 4D and as described above, as appropriate.

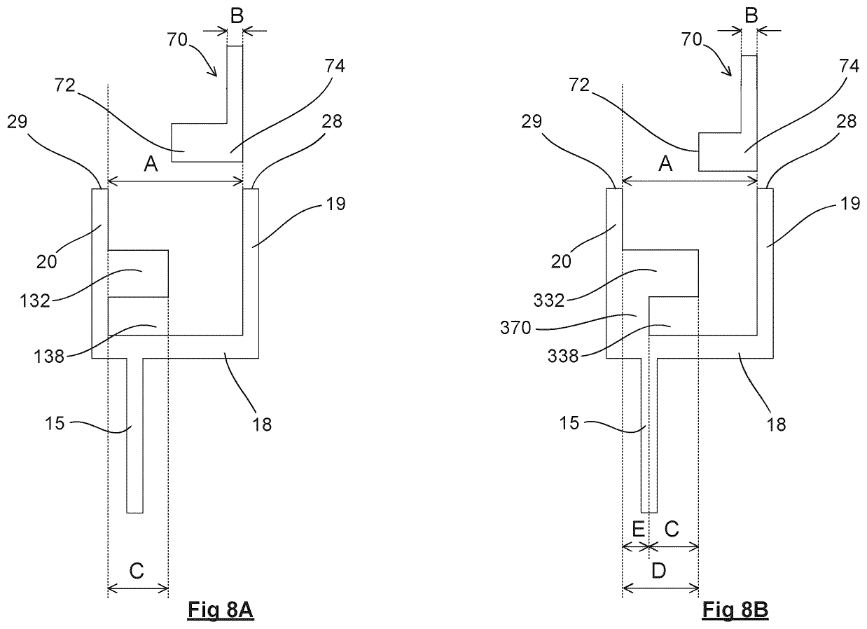

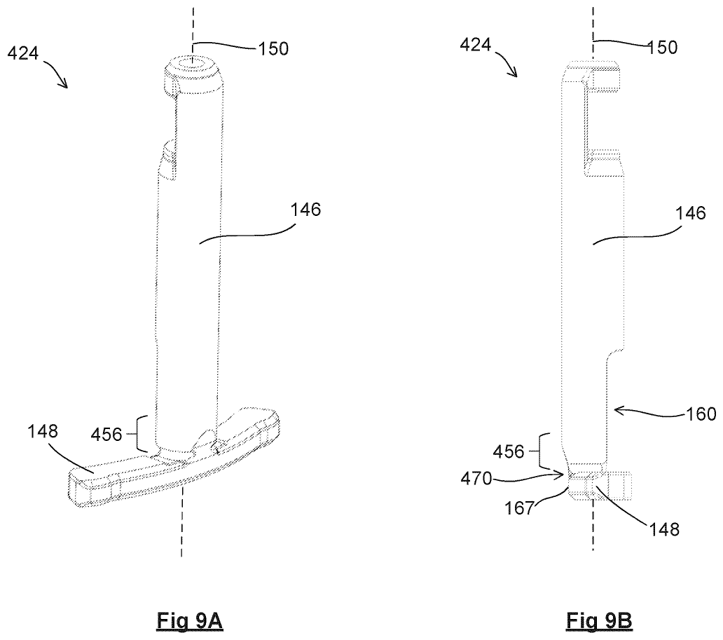

The main difference between the new nozzle ring 312 of FIGS. 7A to 7B and the nozzle ring 112 shown in FIGS. 2A to 2C and 4A to 4D is that radial extent of the second gap 338 is less than a radial extent of the two protrusions 330, 332. This is achieved by providing an addition portion 370 of the two protrusions 330, 332 between: a main part of the protrusions, the outer flange 20 and the generally annular wall 18. Note that the additional portion 370 extends radially inwards from the outer flange 20 and effectively (locally, in the vicinity of the two protrusions 330, 332) moves an inner wall of the outer flange 20 radially inwards. Advantageously, such an arrangement may allow for a reduced radial gap 358 between distal ends of the two protrusions 330, 332 and the inner flange 19. In other words, such an arrangement can allow the two protrusions 330, 332 to extend further towards the inner flange 19, as now discussed with reference to FIGS. 8A and 8B.

FIG. 8A schematically shows a partial cross section of the nozzle ring 112 shown in FIGS. 2A to 2C through the line 8A-8A that passes through one of the protrusions 132, as indicated in FIG. 2B. Also schematically shown in FIG. 8A is a cutting tool 70 of the form described above with reference to FIG. 5.

As shown in FIG. 8A, there is a radial gap A between the inner and outer flanges 19, 20. As explained above, in some embodiments, the second gap 138 (defined between the generally annular wall 18 and the two protrusions 130, 132) may be at least partially formed and/or finished using a cutting tool 70 having a cutting portion 72 that moves axially through the radial gap 158 defined between distal ends of the two protrusions 130, 132 and the inner flange 19 and then radially towards the two protrusions 130, 132 to form or finish the second gap 138. Allowing for sufficient space for the cutting portion 72 and a support 74 therefor may impose a maximum radial extent of the two protrusions 130, 132 between the inner flange 19 and the outer flange 20. For example, if a radial extent of the support 74 for the cutting portion is B and the radial extent of the second gap 138 is equal to the radial extent of the two protrusions 130, 132 (i.e. the second gap 138 extends from the outer flange 20) then the radial extent of the two protrusions 130, 132 will be less than (A−B)/2. That is, the radial extent of the two protrusions will be less than A/2 (since some support 74 is required for the cutting portion and therefore B≠0).

FIG. 8B schematically shows a partial cross section of the nozzle ring 312 shown in FIGS. 7A to 7B through the line 8B-8B that passes through one of the protrusions 332, as indicated in FIG. 7B. Also schematically shown in FIG. 8A is a cutting tool 70 of the form described above with reference to FIG. 5.

As shown in FIG. 8B, due to the additional portion 370 of the two protrusions 330, 332 the radial extent C of the second 338 gap is less than a radial extent D of the two protrusions 330, 332 by some amount E (i.e. C=D−E). With such an arrangement, the radial extent of the second gap 338 will be less than (A−B−E)/2. But the radial extent D of the two protrusions 330, 332 is C+E so the radial extent of the two protrusions 330, 332 will be less than (A−B+E)/2. That is, the maximum radial extent D of the two protrusions 330, 332 is now increased (relative to the arrangement shown in FIG. 8A) by E/2.

Advantageously, this may allow the protrusions 330, 332 to extend further from one of the outer flange 20 such that protrusions 330, 332 radially overlap with the centre line or axis 150 of the cylindrical portion 146 of the support rods 124. Such an arrangement may, for example, be combined with the new support 424 shown in FIG. 9A to 9D and described below, wherein a portion of the support 424 received in the first gap 336 is generally cylindrical. Such an arrangement would eliminate any dependence of the clearance between the nozzle ring 312 and the supports 424 on the rotation of the supports 424 about their axes 150.

It will be appreciated that the new features of the nozzle ring 212 shown in FIGS. 6A and 6B may be combined with the new features of the nozzle ring 312 shown in FIGS. 7A and 7B.

FIGS. 9A to 9D show two different views of a new support 424 for a nozzle ring that is a variant of the support 124 shown in FIGS. 3A to 3D and 4A to 4D. Features that are common to the new support 324 of FIGS. 9A to 9D and the support 124 shown in FIGS. 3A to 3D and 4A to 4D and which are substantially unchanged share common reference numerals. Features of the new support 424 of FIGS. 9A to 9D which differ from corresponding features of the support 124 shown in FIGS. 3A to 3D and 4A to 4D have a reference numeral which is incremented by 300 relative to the corresponding features of the support shown in FIGS. 3A to 3D and 4A to 4D. In the following only the differences between the new support 424 of FIGS. 9A to 9D and the support shown in FIGS. 3A to 3D and 4A to 4D are described in detail. It will be appreciated that the new support 424 of FIGS. 9A to 9D may have any of the features, functionality or advantages of the support shown in FIGS. 3A to 3D and 4A to 4D and as described above, as appropriate.

The main difference between the new support 424 of FIGS. 9A to 9D and the support 124 shown in FIGS. 3A to 3D and 4A to 4D is that a portion 456 of the body proximate the arcuate head portion 147 is generally cylindrical. That is, the intermediate portion 156 of the support shown in FIG. 3 (which defines two parallel surfaces 164, 165) is replaced by an intermediate portion 456 that is cylindrical.

The new support 424 shown in FIGS. 9A to 9D is advantageous, as now discussed. The new support 424 is generally of the type shown in FIG. 3A to 3D, which is disclosed in GB2111046.5 (which was unpublished at the priority date of the present application).

The new support 424 is suitable for supporting the new nozzle ring 212 shown in FIGS. 6A and 6B or the new nozzle ring 312 shown in FIGS. 7A and 7B. FIGS. 10A to 10E show the engagement between the new nozzle ring 312 shown in FIGS. 7A and 7B and two new supports 424 as shown in FIGS. 9A to 9B.

In the arrangement shown in FIGS. 2A to 4D, an intermediate portion 156 of the support rods 124 between the arcuate head portion 148 and the generally cylindrical portion 146 defines two parallel surfaces 164, 165. The intermediate portion 156 is received in the first gap 136 of the nozzle ring 112 (between the two protrusions 130, 132). A clearance between the two protrusions 130, 132 and the intermediate portion 156 of the support rod 124 is minimised such that any torque applied to the nozzle ring 112 (for example by exhaust gases) can be carried by the surfaces of the two protrusions 130, 132 that define the first gap.

In contrast, the portion 456 of the body of the support 424 shown in FIGS. 9A to 9D proximate the arcuate head portion 148 is generally cylindrical. This is advantageous, since the support 424 provides an arrangement similar to the support 124 shown in FIGS. 3a to 3D but which can be more easily combined with the conformal vanes and slots (and the associated advantage of improved turbine stage efficiency) taught in GB2555872, as now discussed.

As explained above, in order to achieve a rivetless nozzle ring that can benefit from the advantages of conformal vanes and slots, sufficient clearance should be provided between the nozzle ring and the support rods such that the nozzle ring is never, in use, rotationally constrained by the support rods. The inventors have realized that, in use, each of the support rods 124, 424 will rotate about the axis 150 of the cylindrical portion 146 (that is received in a guide bush) freely until it contacts the nozzle ring 112, 212, 312. Furthermore, if the first gap 136, 236, 336 and the intermediate portion 146, 456 of the support rod 124, 424 received therein are each defined by two parallel surfaces (as is the case for the support 124 of FIG. 3), such rotation will reduce a clearance between the support rods 124 and the nozzle ring 112, 212, 312. In effect, the two parallel surfaces 164, 165 of the intermediate portion 146 mean that the clearance between the nozzle ring 112, 212, 312 and the support rods 124 is dependent on the rotation of the support rods 124 (about their axes 150). As a result, in order to ensure that the nozzle ring 112, 212, 312 will never be rotationally constrained by the push rods 124 a further increased clearance would be required between the nozzle ring 112, 212, 312 and the support rods 124.

With the support 424 for a nozzle ring shown in FIGS. 9A to 9D, the portion 456 of the body that is proximate the arcuate head portion 148 (which in use is received in the first gap 136, 236, 336) is cylindrical. Such an arrangement eliminates any dependence of the clearance between the nozzle ring 112, 212, 312 and the support rods 424 on the rotation of the support rods 424 about their axes 150. Advantageously, this limits the amount of additional clearance that should be provided to accommodate rotation of the support rods 424 about their axes 150.

The two opposed curved surfaces 166, 167 of the arcuate head portion 148 may have a curvature that generally matches the outer flange 20 of a nozzle ring 112, 212, 312. In use, as shown in FIGS. 10A to 10E, one of the two opposed curved surfaces 167 of the arcuate head portion 148 is disposed adjacent the outer flange 20 (from which the two protrusions extend). The two anti-wear protrusions 162 ate defined on that surface 167. In use, the anti-wear protrusions 162 may contact an adjacent surface of the outer flange 20 of the nozzle ring 112, 212, 312. Such contact may provide a physical stop and limit the rotation of the support 424 about the axis 150 of the elongate portion 146.

Another, optional difference between the new support 424 of FIGS. 9A to 9D and the support 124 shown in FIGS. 3A to 3D and 4A to 4D is that a radial extent of the arcuate head portion 148 is reduced (as compared with the support 124 shown in FIGS. 3A to 3D and 4A to 4D). This, is because the new support 424 of FIGS. 9A to 9D is configured to support the new nozzle ring 312 shown in FIGS. 3A and 3B, the two protrusions 330, 332 of which comprise an addition portion 370. As best shown in FIG. 9B, a recess 470 is defined on an end of body adjacent the arcuate head portion 148 for receipt of the additional portions 370 of the protrusions 330, 332 of the new nozzle ring 312 shown in FIGS. 3A and 3B.

According to some embodiments, there is provided an assembly comprising: a nozzle generally of the type shown in FIGS. 2A to 2C and at least one support (for example two supports) generally of the type shown in FIGS. 3A to 3D. The arcuate head portion of each of the at least one supports may be received in the second gap defined between the generally annular wall and a pair of two protrusions of the nozzle ring. The nozzle ring and the or each support may be arranged such that there is an angular clearance between the nozzle ring and the or each support, the angular clearance being localized and defined by two portions of the nozzle ring and wherein a line that connects said two portions of the nozzle ring passes through, or is proximate to an axis of the elongate portion.

Examples of such assemblies are now discussed with reference to FIGS. 10 and 11.

It will be appreciated that the nozzle ring and supports may be provided in a disassembled state and according to some embodiments, there is provided a kit of parts comprising the parts of the assembly.

As can be best seen in FIG. 10E, when assembled together, there is an angular clearance between the new nozzle ring 312 shown in FIG. 7 and the new support 424 shown in FIG. 9 which is localized (since the portion of the new support disposed in the first gap 336 is cylindrical). Furthermore, since the two protrusions 330, 332 of the new nozzle ring extend further from the outer flange 20 (than the protrusions of the nozzle ring 112 shown in FIG. 2 do), the angular clearance is defined by two portions of the nozzle ring (on the two protrusions 330, 332) wherein a line (dotted line in FIG. 10E) that connects said two portions of the nozzle ring passes through an axis 150 of the elongate portion 146 of the support 424. In contrast, the angular clearance between the nozzle ring 112 and supports 124 shown in FIG. 4 is an elongate clearance (defined by flat surfaces of the protrusions 130, 132 and the intermediate portion 156) and no line can be drawn between the parts of the nozzle ring 112 that define the clearance which passes through the axis 150 of the support 124.

As can be seen in FIG. 11, when assembled together, there is an angular clearance between the new nozzle ring 212 shown in FIG. 6 and the support 124 shown in FIG. 3 which is localized (provided by portions 272, 274 of the two protrusions 230, 232 proximate a distal end of each of the two protrusions 230, 232). Furthermore, the angular clearance is defined by two portions 272, 274 of the nozzle ring 212 such that wherein a line (dot-dash line in FIG. 11) that connects said two portions 272, 274 of the nozzle ring is proximate to an axis 150 of the elongate portion 146 of the support 124.

Advantageously, the arrangements of FIGS. 10 and 11 limits the extent to which the orientation of the supports 124, 424 affects the clearance between the nozzle ring 212, 312 and the or each support 124, 424.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below.

1. A nozzle ring for a variable geometry turbine, the nozzle ring comprising:
a generally annular wall;
an inner flange that is generally perpendicular to the generally annular wall, and which extends from a radially inner edge of the generally annular wall;
an outer flange that is generally perpendicular to the generally annular wall, and which extends from a radially outer edge of the generally annular wall; and
two protrusions extending from one of the inner or outer flange towards the other one of the inner or outer flange, at least one of the two protrusions extending only partially towards the other one of the inner or outer flange;
wherein the two protrusions define a first gap therebetween;
wherein the generally annular wall and the two protrusions define a second gap between the generally annular wall and both of the two protrusions; and
wherein a radial extent of the second gap is less than a radial extent of the two protrusions.

2. A nozzle ring for a variable geometry turbine, the nozzle ring comprising:
a generally annular wall;
an inner flange that is generally perpendicular to the generally annular wall, and which extends from a radially inner edge of the generally annular wall;
an outer flange that is generally perpendicular to the generally annular wall, and which extends from a radially outer edge of the generally annular wall; and
two protrusions extending from one of the inner or outer flange towards the other one of the inner or outer flange, at least one of the two protrusions extending only partially towards the other one of the inner or outer flange;
wherein the two protrusions define a first gap therebetween;
wherein the generally annular wall and the two protrusions define a second gap between the generally annular wall and both of the two protrusions; and
wherein the two protrusions are such that the first gap is tapered so that a dimension of the gap is smaller at a distal end of the protrusions and larger proximate to the inner or outer flange from which the two protrusions extend.

3. The nozzle ring of claim 2 wherein a radial extent of the second gap is less than a radial extent of the two protrusions.

4. The nozzle ring of claim 2 wherein the surfaces of the two protrusions that define the first gap are inclined relative to each other by at least 8 degrees so as to provide the tapered first gap.

5. The nozzle ring of claim 1 wherein at least one of:
the inner and outer flanges extend further from the generally annular wall than the two protrusions;
the two protrusions are integrally formed with the one of the inner and outer flanges from which they extend; and
both of the two protrusions extend only partially towards the other one of the inner or outer flange.

6. (canceled)

7. (canceled)

8. The nozzle ring of claim 1 wherein at least one of:
a radial extent of the at least one of the two protrusions extending only partially towards the other one of the inner or outer flange is between 0.25 and 0.75 times a radial distance between the inner flange and the outer flange;
the generally annular wall supports a plurality of circumferentially spaced inlet vanes each of which extends axially away from a surface of the generally annular wall opposite from the inner and outer flanges; and
wherein a plurality of axially extending apertures are provided through the generally annular wall.

9. (canceled)

10. (canceled)

11. The nozzle ring of claim 9, wherein a plurality of axially extending apertures are provided through the generally annular wall, and wherein at least some of the axially extending apertures provided through the generally annular wall are located between the inlet vanes.

12. The nozzle ring of claim 1 further comprising a second set of two protrusions extending from one of the inner or outer flange towards the other one of the inner or outer flange, at least one of the second set of two protrusions extending only partially towards the other one of the inner or outer flange;
wherein the two protrusions of the second set define a third gap therebetween; and
wherein the generally annular wall and the two protrusions of the second set define a fourth gap between the generally annular wall and both of the two protrusions of the second set.

13. The nozzle ring of claim 12 wherein at least one of:
the second set of two protrusions are such that the third gap is tapered so that a dimension of the gap is smaller at a distal end of the protrusions of the second set and larger proximate to the inner or outer flange from which the two protrusions of the second set extend; and
a radial extent of the fourth gap is less than a radial extent of the second set of two protrusions.

14. (canceled)

15. A support for a nozzle ring, the support comprising:
a body, the body comprising:
an elongate portion; and
an arcuate head portion disposed adjacent one end of the elongate portion, the head portion extending generally perpendicular to an axis of the elongate portion;
wherein the arcuate head portion defines a two opposed curved surfaces and wherein at least one of the two opposed curved surfaces defines one or more protrusions therefrom; and
wherein a portion of the body proximate the arcuate head portion is generally cylindrical.

16. The support of claim 15 wherein a bisector of the arcuate head portion in a plane perpendicular to the axis of the generally cylindrical portion is offset from said axis, and wherein a recess is defined on the end of the elongate portion adjacent the arcuate head portion, the recess defined on a side of the elongate portion opposite to a direction in which the bisector of the arcuate head portion is offset from said axis in the plane perpendicular to said axis.

17. (canceled)

18. A kit of parts comprising:
a nozzle ring for a variable geometry turbine, the nozzle ring comprising:
a generally annular wall;
an inner flange that is generally perpendicular to the generally annular wall, and which extends from a radially inner edge of the generally annular wall;
an outer flange that is generally perpendicular to the generally annular wall, and which extends from a radially outer edge of the generally annular wall; and
two protrusions extending from one of the inner or outer flange towards the other one of the inner or outer flange, at least one of the two protrusions extending only partially towards the other one of the inner or outer flange;
wherein the two protrusions define a first gap therebetween; and
wherein the generally annular wall and the two protrusions define a second gap between the generally annular wall and both of the two protrusions; and
at least one support for a nozzle ring, the support comprising:
a body, the body comprising:
an elongate portion; and
an arcuate head portion disposed adjacent one end of the elongate portion, the head portion extending generally perpendicular to an axis of the elongate portion;
wherein an external axial dimension of the arcuate head portion of the at least one support generally matches an internal axial dimension of the second gap;
wherein the nozzle ring and the at least one support are configured such that the arcuate head portion of the at least one support is receivable in the second gap and a portion of the at least one support is disposed in the first gap; and
wherein the nozzle ring and the or each support are arranged such that when the arcuate head portion of the at least one support is received in the second gap and a portion of the at least one support is disposed in the first gap there is an angular clearance between the nozzle ring and the or each support, the angular clearance being localized and defined by two portions of the nozzle ring and wherein a line that connects said two portions of the nozzle ring passes through, or is proximate to an axis of the elongate portion.

19. An assembly comprising:
a nozzle ring for a variable geometry turbine, the nozzle ring comprising:
a generally annular wall;
an inner flange that is generally perpendicular to the generally annular wall, and which extends from a radially inner edge of the generally annular wall;
an outer flange that is generally perpendicular to the generally annular wall, and which extends from a radially outer edge of the generally annular wall; and
two protrusions extending from one of the inner or outer flange towards the other one of the inner or outer flange, at least one of the two protrusions extending only partially towards the other one of the inner or outer flange;
wherein the two protrusions define a first gap therebetween; and
wherein the generally annular wall and the two protrusions define a second gap between the generally annular wall and both of the two protrusions; and
at least one support for a nozzle ring, the support comprising:
a body, the body comprising:
an elongate portion; and
an arcuate head portion disposed adjacent one end of the elongate portion, the head portion extending generally perpendicular to an axis of the elongate portion;
wherein an external axial dimension of the arcuate head portion of the at least one support generally matches an internal axial dimension of the second gap;
wherein the arcuate head portion of the at least one support is received in the second gap and a portion of the at least one support is disposed in the first gap; and
wherein the nozzle ring and the or each support are arranged such that there is an angular clearance between the nozzle ring and the or each support, the angular clearance being localized and defined by two portions of the nozzle ring and wherein a line that connects said two portions of the nozzle ring passes through, or is proximate to an axis of the elongate portion.

20. An assembly comprising the kit of parts of claim 18 wherein the arcuate head portion of the at least one support is received in the second gap and a portion of the at least one support is disposed in the first gap; and
wherein the nozzle ring and the or each support are arranged such that there is an angular clearance between the nozzle ring and the or each support, the angular clearance being localized and defined by two portions of the nozzle ring and wherein a line that connects said two portions of the nozzle ring passes through, or is proximate to an axis of the elongate portion.

21. The kit of parts of claim 18, wherein the nozzle ring comprises a nozzle ring comprising:
a generally annular wall;
an inner flange that is generally perpendicular to the generally annular wall, and which extends from a radially inner edge of the generally annular wall;
an outer flange that is generally perpendicular to the generally annular wall, and which extends from a radially outer edge of the generally annular wall; and
two protrusions extending from one of the inner or outer flange towards the other one of the inner or outer flange, at least one of the two protrusions extending only partially towards the other one of the inner or outer flange;
wherein the two protrusions define a first gap therebetween;
wherein the generally annular wall and the two protrusions define a second gap between the generally annular wall and both of the two protrusions; and
wherein a radial extent of the second gap is less than a radial extent of the two protrusions.

22. The kit of parts of claim 1 wherein the or each at least one support comprises a support comprising:
a body, the body comprising:
an elongate portion; and
an arcuate head portion disposed adjacent one end of the elongate portion, the head portion extending generally perpendicular to an axis of the elongate portion;
wherein the arcuate head portion defines a two opposed curved surfaces and wherein at least one of the two opposed curved surfaces defines one or more protrusions therefrom; and
wherein a portion of the body proximate the arcuate head portion is generally cylindrical.

23. A variable geometry turbine comprising:
a housing;
a turbine wheel supported in the housing for rotation about an axis;
a nozzle ring according to claim 1;
a cavity provided in the housing for receipt of the inner and outer flanges of the nozzle ring, the nozzle ring being axially movable relative to the housing to vary the extent to which the inner and outer flanges of the nozzle are received in the cavity; and
an inlet passageway extending radially inwards towards the turbine wheel and defined between a face of the generally annular wall of the nozzle ring and an opposing wall of the housing, such that said axial movement of the nozzle ring relative to the housing varies the axial width of the inlet passageway.

24. The variable geometry turbine of claim 23, wherein the generally annular wall supports a plurality of circumferentially spaced inlet vanes each of which extends axially away from a surface of the generally annular wall opposite from the inner and outer flanges, and wherein the opposing wall of the housing defines a plurality of circumferentially spaced slots arranged such that each of the plurality of inlet vanes is received in a respective one of the plurality of slots.

25. A turbocharger comprising the variable geometry turbine of claim 23.

26. A method of assembling a variable geometry turbine, the method comprising:
providing a nozzle ring comprising a plurality of inlet vanes;
providing two supports for a nozzle ring;
engaging the two supports with the nozzle ring so as to form a nozzle ring assembly;
coupling the two supports of the nozzle ring assembly with a first housing member such that the two supports cannot rotate freely about a main axis of the variable geometry turbine relative to the first housing member;
providing a shroud that defines a plurality slots and which is fixed to a second housing member such that the shroud cannot rotate freely about a main axis of the variable geometry turbine relative to the second housing member;
engaging the nozzle ring assembly with the shroud such that each of the plurality of inlet vanes is received in a respective one of the plurality of slots; and
fixing the first housing member to the second housing member such that the rotation of the nozzle ring about the main axis of the variable geometry turbine is not constrained by the two supports.
